(19) United States
(12) Patent Application Publication
(10) Pub. No.: US 2016/0275911 A1
(43) Pub. Date: Sep. 22, 2016

(54) INFORMATION PROCESSING DEVICE AND PROGRAM

(71) Applicant: Semiconductor Energy Laboratory Co., Ltd., Atsugi-shi (JP)

(72) Inventors: Daisuke KUBOTA, Atsugi (JP); Yusuke KUBOTA, Atsugi (JP); Koji KUSUNOKI, Kawasaki (JP); Shunpei YAMAZAKI, Tokyo (JP)

(21) Appl. No.: 15/066,082

(22) Filed: Mar. 10, 2016

(30) Foreign Application Priority Data
Mar. 17, 2015 (JP) 2015-052913
Mar. 20, 2015 (JP) 2015-057168

(51) Int. Cl. G09G 5/08; G09G 3/36; G09G 5/10; G06F 3/01; G06F 3/02; G06F 3/041; G06F 3/16; G09G 3/20; G06F 3/033

(52) U.S. Cl. CPC G09G 5/08; G09G 3/2003; G09G 3/3607; G09G 5/10; G06F 3/033; G06F 3/02; G06F 3/041; G06F 3/167; G06F 3/017; G06F 3/013; G09G 2320/0626; G09G 2320/066; G09G 2300/0452

(57) ABSTRACT

A novel information processing device that is highly convenient or reliable is provided. Alternatively, a novel program that is highly convenient or reliable is provided. The information processing device includes the input/output device that supplies positional information and receives image information and the arithmetic device that receives the positional information and supplies the image information. The arithmetic device determines the contrast or brightness of image information in accordance with the moving speed of the pointer.

### BACKGROUND OF THE INVENTION

1. Field of the Invention

One embodiment of the present invention relates to an information processing device, a program, or a semiconductor device.

Note that one embodiment of the present invention is not limited to the above technical field. The technical field of one embodiment of the invention disclosed in this specification and the like relates to an object, a method, or a manufacturing method. In addition, one embodiment of the present invention relates to a process, a machine, manufacture, or a composition of matter. Specifically, examples of the technical field of one embodiment of the present invention disclosed in this specification include a semiconductor device, a display device, a light-emitting device, a power storage device, a memory device, a method for driving any of them, and a method for manufacturing any of them.

2. Description of the Related Art

A method is known in which an information processing device including a display portion and an input portion is driven in the following steps: a first step of acquiring an input signal with the input portion, a second step of starting the movement of an image displayed on the display portion in accordance with the input signal, a third step of reducing the luminance of the image, a fourth step of judging whether the image has reached predetermined coordinates or not, a fifth step of increasing the luminance of the image when it is determined that the image has reached the predetermined coordinates, and a sixth step of stopping the movement of the image. This method can reduce eye fatigue of a user and achieve eye-friendly display (Patent Document 1).

### REFERENCE

### Patent Document

[Patent Document 1] Japanese Published Patent Application No. 2014-115641

### SUMMARY OF THE INVENTION

An object of one embodiment of the present invention is to provide a novel information processing device that is highly convenient or reliable. Another object of one embodiment of the present invention is to provide a novel program that is highly convenient or reliable. Another object of one embodiment of the present invention is to provide a novel information processing device, a novel program, or a novel semiconductor device.

Note that the description of these objects does not disturb the existence of other objects. In one embodiment of the present invention, there is no need to achieve all the objects. Other objects will be apparent from and can be derived from the description of the specification, the drawings, the claims, and the like.

(1) One embodiment of the present invention is an information processing device that includes an arithmetic device and an input/output device.

The arithmetic device is configured to receive positional information and supply image information and control information.

The input/output device is configured to supply the positional information and receive the image information and the control information.

The input/output device includes a display portion that displays the image information and an input portion that supplies the positional information.

The display portion includes a reflective liquid crystal element and a pixel circuit electrically connected to the liquid crystal element.

The input portion is configured to detect the position of a pointer and supply positional information determined in accordance with the position.

The arithmetic device is configured to determine the moving speed of the pointer in accordance with the positional information.

The arithmetic device is configured to determine the contrast or brightness of image information in accordance with the moving speed of the pointer.

The above-described information processing device of one embodiment of the present invention includes the input/output device that supplies positional information and receives image information and the arithmetic device that receives the positional information and supplies the image information. The arithmetic device determines the contrast or brightness of image information in accordance with the moving speed of the pointer. With this structure, eyestrain on a user caused when the display position of image information is moved can be reduced, that is, eye-friendly display can be achieved. Thus, the novel information processing device that is highly convenient or reliable can be provided.

(2) Another embodiment of the present invention is the information processing device in which the pixel circuit includes a transistor including an oxide semiconductor.

(3) Another embodiment of the present invention is a program of an information processing device. The program includes first to eighth steps described below.

In the first step, the setting is initialized.

In the second step, interrupt processing is allowed.

In the third step, image information is displayed in a mode selected in the first step or the interrupt processing.

In the fourth step, the program moves to the fifth step when a termination instruction is supplied, and the program moves to the third step when the termination instruction is not supplied.

In the fifth step, the program terminates.

The interrupt processing includes sixth to eighth steps described below.

In the sixth step, the program moves to the seventh step when the predetermined event is supplied, and the program moves to the eighth step when the predetermined event is not supplied.

In the seventh step, the mode is changed.

In the eighth step, the interrupt processing is completed.

When the first mode is selected and the moving speed of the pointer is higher than a predetermined speed in the third step, image information having a lower contrast than image information in the second mode is displayed; when the moving speed of the pointer is lower than the predetermined speed, image information having a higher contrast than the image information in the second mode is displayed.

The program of one embodiment of the present invention includes a step of displaying an image whose contrast of the image is changed in accordance with the moving speed of the pointer when the predetermined event is supplied. With this structure, eyestrain on a user caused when the display position of image information is moved can be reduced, that is, eye-friendly display can be achieved. Thus, the novel program that is highly convenient or reliable can be provided.

(4) Another embodiment of the present invention is a program of an information processing device that displays image information in the third step under conditions described below.

When the second mode is selected in the third step, a selection signal is supplied at a lower frequency than when the first mode is selected.

The program of one embodiment of the present invention includes a step of displaying an image with a selection signal supplied at a low frequency when the predetermined event is not supplied. With this structure, eyestrain on a user caused when a still image is displayed can be reduced, that is, eye-friendly display can be achieved. Thus, the novel program that is highly convenient or reliable can be provided.

(5) Another embodiment of the present invention is the above-mentioned information processing device in which the display portion includes a pixel for displaying blue, a pixel for displaying green, and a pixel for displaying red.

The area of the pixel for displaying blue is larger than the area of a pixel for displaying a color other than blue.

This pixel configuration enables favorable white display. Thus, the novel information processing device that is highly convenient or reliable can be provided.

(6) Another embodiment of the present invention is the above-mentioned information processing device in which the reflective liquid crystal element includes a liquid crystal layer and a conductive film that reflects light entering through the liquid crystal layer.

The conductive film has a region overlapping with a semiconductor film and a conductive film functioning as a gate electrode of a transistor. The semiconductor film is disposed between the conductive film and the conductive film functioning as a gate electrode.

In the information processing device of one embodiment of the present invention, the conductive film which reflects light entering through the liquid crystal layer in the reflective liquid crystal element has a region overlapping with the transistor, and a conductive film functioning as a second gate is provided between the conductive film and the transistor. With this structure, a change in transistor characteristics which is caused by operation of the liquid crystal element can be inhibited. Thus, the novel information processing device that is highly convenient or reliable can be provided.

(7) Another embodiment of the present invention is the above-mentioned information processing device in which the input portion includes at least one of a keyboard, a hardware button, a pointing device, a touch sensor, an imaging device, an audio input device, a viewpoint input device, and a pose detection device. Thus, the information processing device can have low power consumption and excellent visibility even in a bright place. Thus, the novel information processing device that is highly convenient or reliable can be provided.

Although the block diagram attached to this specification shows components classified by their functions in independent blocks, it is difficult to classify actual components according to their functions completely and it is possible for one component to have a plurality of functions.

In this specification, the terms “source” and “drain” of a transistor interchange with each other depending on the polarity of the transistor or the levels of potentials applied to the terminals. In general, in an n-channel transistor, a terminal to which a lower potential is applied is called a source, and a terminal to which a higher potential is applied is called a drain. Further, in a p-channel transistor, a terminal to which a lower potential is applied is called a drain, and a terminal to which a higher potential is applied is called a source. In this specification, although connection relation of the transistor is described assuming that the source and the drain are fixed in some cases for convenience, actually, the names of the source and the drain interchange with each other depending on the relation of the potentials.

Note that in this specification, a “source” of a transistor means a source region that is part of a semiconductor film functioning as an active layer or a source electrode connected to the semiconductor film. Similarly, a “drain” of the transistor means a drain region that is part of the semiconductor film or a drain electrode connected to the semiconductor film. A “gate” means a gate electrode.

Note that in this specification, a state in which transistors are connected to each other in series means, for example, a state in which only one of a source and a drain of a first transistor is connected to only one of a source and a drain of a second transistor. In addition, a state in which transistors are connected to each other in parallel means a state in which one of a source and a drain of a first transistor is connected to one of a source and a drain of a second transistor and the other of the source and the drain of the first transistor is connected to the other of the source and the drain of the second transistor.

In this specification, the term “connection” means electrical connection and corresponds to a state where current, voltage, or a potential can be supplied or transmitted. Accordingly, a connection state means not only a state of direct connection but also a state of indirect connection through a circuit element such as a wiring, a resistor, a diode, or a transistor that allows current, voltage, or a potential to be supplied or transmitted.

In this specification, even when different components are connected to each other in a circuit diagram, there is actually a case where one conductive film has functions of a plurality of components such as a case where part of a wiring serves as an electrode. The term “connection” also means such a case where one conductive film has functions of a plurality of components.

In addition, in this specification, one of a first electrode and a second electrode of a transistor refers to a source electrode and the other refers to a drain electrode.

One embodiment of the present invention can provide a novel information processing device that is highly convenient or reliable. Alternatively, a novel program that is highly convenient or reliable can be provided. Alternatively, a novel information processing device, a novel program, or a novel semiconductor device can be provided.

Note that the description of these effects does not disturb the existence of other effects. One embodiment of the present invention does not necessarily achieve all the effects listed above. Other effects will be apparent from and can be derived from the description of the specification, the drawings, the claims, and the like.

### BRIEF DESCRIPTION OF THE DRAWINGS

FIG. 1A illustrates a configuration of an information processing device of one embodiment and FIG. 1B schematically illustrates an example of a state where the information processing device is used.

FIGS. 2A to 2D illustrate configurations of display portions of embodiments.

FIGS. 3A and 3B are flow charts showing a program of one embodiment.

FIG. 4 schematically illustrates a method for displaying image information of one embodiment.

FIGS. 5A to 5D schematically illustrate an optic nerve and a transfer function of one embodiment.

FIGS. 6A to 6D schematically illustrate a visual transfer function of one embodiment.

FIGS. 7A to 7C schematically illustrate a structure of image information of one embodiment.

FIG. 8 is a top view illustrating a structure of a display module of one embodiment.

FIGS. 9A and 9B are each a top view illustrating a pixel configuration of one embodiment.

FIGS. 10A to 10C are cross-sectional views illustrating a structure of a display module of one embodiment.

FIGS. 11A and 11B are cross-sectional views illustrating a structure of a display module of one embodiment.

FIGS. 12A and 12B are cross-sectional views illustrating a structure of a display module of one embodiment.

FIGS. 13A and 13B are cross-sectional views illustrating a structure of a display module of one embodiment.

FIGS. 14A to 14D illustrate a structure of a transistor of one embodiment.

FIGS. 15A to 15C illustrate a structure of a transistor of one embodiment.

FIGS. 16A and 16B illustrate a structure of a touch panel of one embodiment.

FIG. 17 illustrates a structure of a display module of one embodiment.

FIGS. 18A to 18H each illustrate a structure of an electronic device of one embodiment.

FIGS. 19A to 19C illustrate a configuration of a display portion of an information processing device of Example.

FIGS. 20A and 20B illustrate a configuration of a pixel in an information processing device of Example.

FIGS. 21A and 21B show characteristics of an information processing device of Example.

### DETAILED DESCRIPTION OF THE INVENTION

The above-described information processing device of one embodiment of the present invention includes the input/output device that supplies positional information and receives image information and the arithmetic device that receives the positional information and supplies the image information. The arithmetic device determines the contrast or brightness of image information in accordance with the moving speed of the pointer.

With this structure, eyestrain on a user caused when the display position of image information is moved can be reduced, that is, eye-friendly display can be achieved. Thus, the novel information processing device that is highly convenient or reliable can be provided.

### <Display Method in Which Influence of Lateral Inhibition is Avoided>

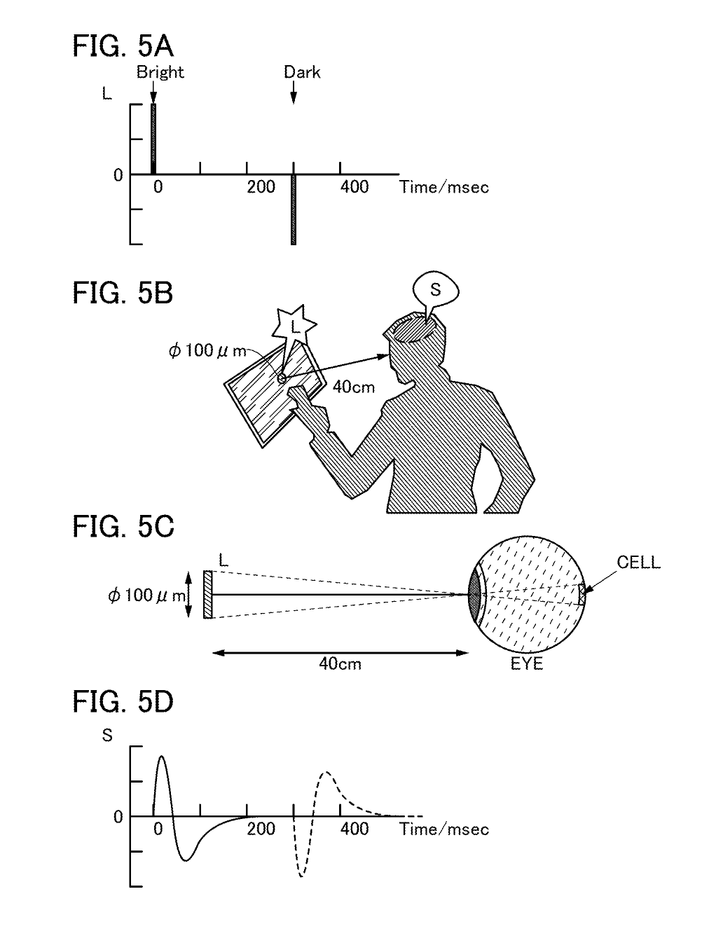

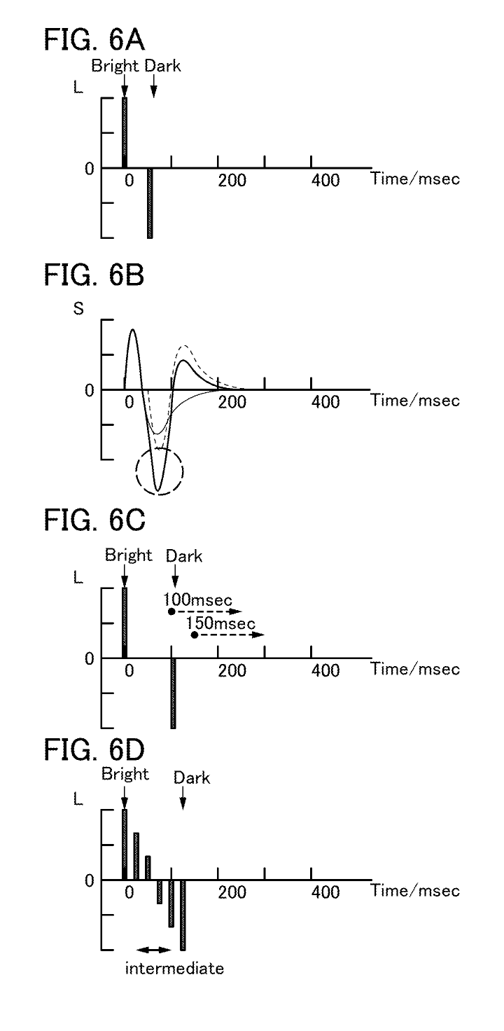

A display method in which an influence of lateral inhibition is avoided will be described with reference to FIGS. 5A to 5D and FIGS. 6A to 6D.

FIGS. 5A to 5D schematically illustrate an optic nerve and a visual transfer function. FIG. 5A schematically illustrates an example of stimuli applied to an optic nerve when image information is switched from one to another. FIGS. 5B and 5C schematically illustrate the position of an information processing device including the display portion and the position of a user of the information processing device. FIG. 5D schematically illustrates responses of an optic nerve to the applied stimuli which are transformed in accordance with the visual transfer function. Note that the vertical axis L in FIG. 5A represents the brightness, where the brightness to which the eyes are adapted is assumed to be 0. The vertical axis S in FIG. 5D represents the intensity of a response.

FIGS. 6A to 6D schematically illustrate an optic nerve and a visual transfer function. FIG. 6A schematically illustrates an example of stimuli applied to an optic nerve when image information is switched from one to another. FIG. 6B schematically illustrates responses of an optic nerve to the applied stimuli which are transformed in accordance with the visual transfer function. FIGS. 6C and 6D each schematically illustrate the display method of one embodiment of the present invention, in which amplification of responses to applied stimuli can be suppressed.

### <<Lateral Inhibition>>

A neuron of a stimulated optic nerve is capable of inhibiting activities of adjacent other neurons. This phenomenon may cause transformation of responses to a pulsed visual stimulus.

For example, a bright image and a dark image are displayed in a pulsed manner in a region which is on a plane at a distance of 40 cm from the user's eye and has a diameter of 100 μm (see FIG. 5A). Note that the size of one photoreceptor cell (CELL) corresponds to that of a region which is on a plane at a distance of 40 cm from the user's eye and has a diameter of approximately 100 μm (see FIGS. 5B and 5C).

In some cases, a pulsed stimulus is transformed into wave-shaped responses in accordance with the visual transfer function (see FIGS. 5A and 5D). Specifically, a pulsed positive visual stimulus is transformed into a positive response accompanied with a negative response, whereas a pulsed negative visual stimulus is transformed into a negative response accompanied with a positive response (David C. Burr and M. Concetta Morrone, “Impulse-response functions for chromatic and achromatic stimuli,” Journal of Optical Society of America, 1993, Vol. 10, No. 8, p. 1706).

When a bright image and a dark image are sequentially displayed at a sufficiently short time interval, for example, a response to the preceding stimulus and a response to the following stimulus, which are both wave-shaped, may be superimposed on each other to increase the amplitude.

Specifically, in the case where pulsed dark second image information is displayed 50 msec after pulsed bright first image information is displayed, a positive response to the displayed first image information occurs, and then, a negative response to the displayed first image information occurs. The negative response to the displayed first image information and a negative response to the displayed dark second image information are superimposed in some cases. Accordingly, for example, a significantly amplified negative response might be formed (see FIGS. 6A and 6B).

### <<Display Method>>

In one example, image information is switched from one to another at a time interval of 100 msec or longer, preferably 150 msec or longer, whereby an influence of responses converted into wave shapes using the visual transfer function, specifically, amplification caused by superimposition of a response to a visual stimulus and a response to a subsequent visual stimulus, can be avoided (see FIG. 6C).

For example, intermediate image information is displayed between the preceding image information and the following image information. Specifically, gray image information or image information with an intermediate gray level between the preceding image information and the following image information is displayed (see FIG. 6D). Thus, wave-shaped responses to the preceding stimulus can be canceled by wave-shaped responses to the following stimulus, whereby the amplification can be weakened.

In another example, intermediate image information can be obtained by displaying images in such a manner that the preceding image information fades out while the following image information fades in (this technique is also referred to as cross-fade)

In another example, a display method in which image information that emphasizes a difference is interposed between the preceding image information and the following image information so that the image information is switched from one to another in a short time (this method is also referred to as an overdrive method) is not employed. Thus, the time interval between the preceding image information and the following image information can be prolonged.

In another example, a liquid crystal display element is driven by a method in which image information with a gradual change in gray level is interposed to gradually emphasize a difference between the preceding image information and the following image information.

Accordingly, the influence of lateral inhibition can be avoided. Thus, amplification of responses to visual stimuli can be suppressed.

### <<Image Information a Response to Which is Likely to be Influenced by Lateral Inhibition>>

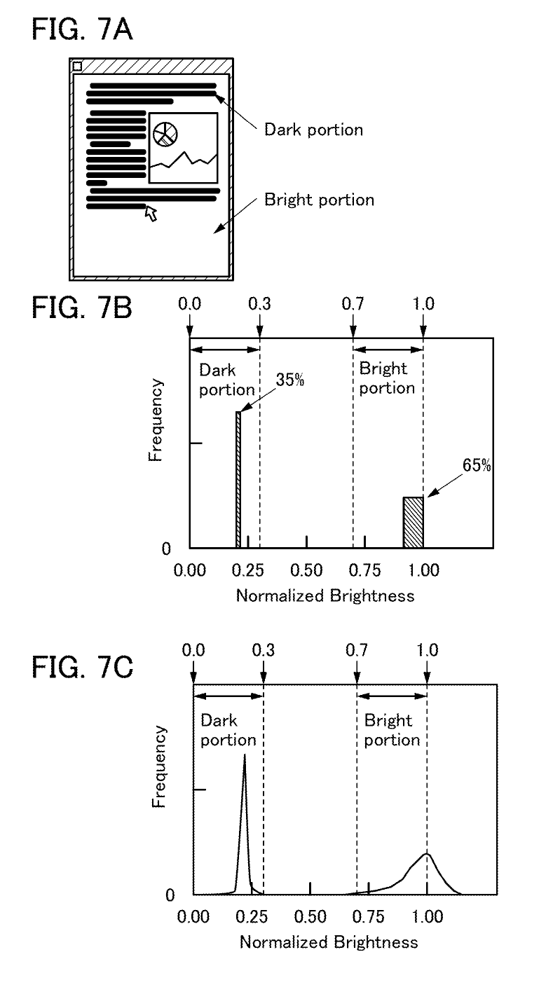

Image information in which a wave-shaped response, which is converted by the visual transfer function, to the preceding stimulus is likely to influence a wave-shaped response to the following stimulus, will be described with reference to FIGS. 7A to 7C. The image information described here may be displayed by any of the above methods, for example.

FIG. 7A schematically illustrates image information including a dark portion and a bright portion.

FIG. 7B is a histogram in which pixels for image information are classified according to the brightness and which shows the area ratio in terms of brightness. Note that the horizontal axis represents the normalized brightness under the assumption that the lowest brightness and the highest brightness of the display portion of the display device are 0 and 1, respectively. The proportion of pixels with certain brightness in the image information can be seen from the area of a bar in the histogram.

FIG. 7C is a diagram (or a histogram) showing the results of determining the area ratio in terms of brightness in a general document in which, for example, texts are printed on white paper. Note that the horizontal axis represents the normalized brightness, where the brightness at which the proportion of the area of the bright portion peaks is 1.

<<Image Information with High Contrast>>

For example, a response to a visual stimulus caused by image information having a bright portion and a dark portion is likely to be influenced by lateral inhibition. Note that the dark portion of the image information has a normalized brightness of greater than or equal to 0 and less than or equal to 0.3, and the bright portion has a normalized brightness of greater than or equal to 0.7 and less than or equal to 1.0.

For example, a response to a visual stimulus caused by image information having a region with a normalized brightness of 0.2 and a region with a normalized brightness of greater than or equal to 0.95 and less than or equal to 1 is likely to be influenced by lateral inhibition (see FIG. 7B).

Note that a response to a visual stimulus caused by image information with a contrast lower than that of a general document (see FIG. 7C) in which texts are printed on white paper is less likely to be influenced by lateral inhibition.

<<Image Information with High Proportion of Dark Portion>>

For example, a response to a visual stimulus caused by image information with a higher proportion of the dark portion than a predetermined proportion is likely to be influenced by lateral inhibition. Specifically, a response to a visual stimulus caused by image information with a proportion of the dark portion of 30% or higher is likely to be influenced by lateral inhibition (see FIG. 7B).

Note that a response to a visual stimulus caused by image information with a proportion of the dark portion lower than that in a general document (in which texts are printed on white paper, see FIG. 7C) is less likely to be influenced by lateral inhibition.

### <Background Color>

The color of a background of image information can be determined in accordance with user's preference.

For example, when a highly creative work that requires power of idea or creativity is performed using image information displayed on the display portion, a more yellowish or darker color than a background color used when a typical office work or the like is performed efficiently is used as the background color of the image information. In that case, energy consumption can be reduced by 40% or more in some cases.

Specifically, a color with a color temperature of higher than or equal to 3000 K and lower than or equal to 4500 K can be used for the background of the image information.

Alternatively, in an environment for the highly creative work, the display portion may be used at an illuminance of higher than or equal to 300 lx and lower than or equal to 800 lx.

In such a manner, image information can be displayed suitably for a highly creative work that requires power of idea or creativity. In addition, energy consumption associated with the use of the display portion can be reduced.

For example, in the above display method, image information with a yellowish or dark background color may be used as intermediate image information between the preceding image information and the following image information. In that case, energy consumption due to a scrolling instruction can be reduced.

Embodiments will be described in detail with reference to the drawings. Note that the present invention is not limited to the following description, and it is easily understood by those skilled in the art that various changes and modifications can be made without departing from the spirit and scope of the present invention. Therefore, the present invention should not be construed as being limited to the description in the following embodiments. In the structures of the invention described below, the same portions or portions having similar functions are denoted by the same reference numerals in different drawings, and description of such portions is not repeated.

### Embodiment 1

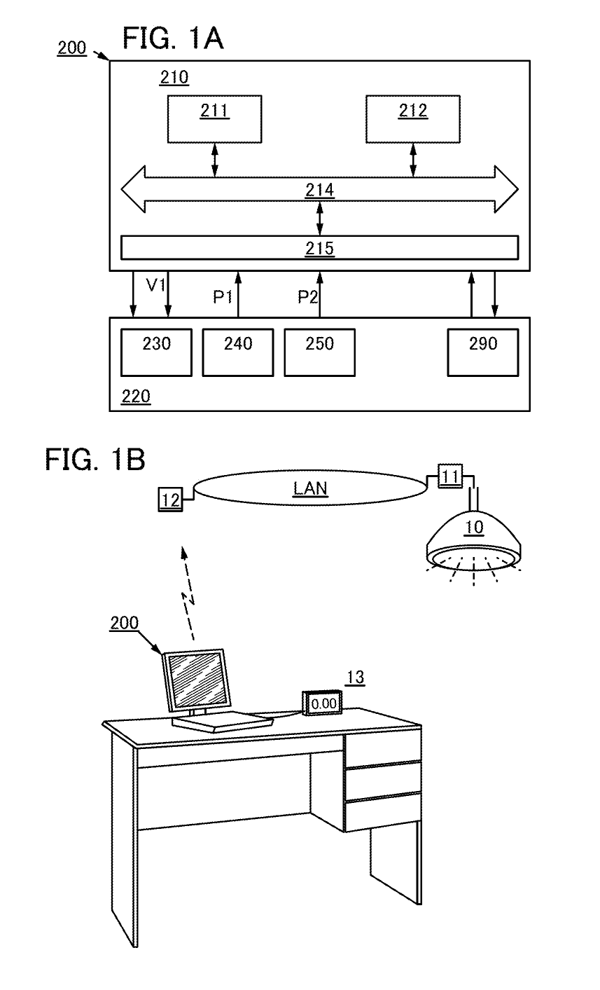

In this embodiment, a structure of an information processing device of one embodiment of the present invention will be described with reference to FIGS. 1A and 1B, FIGS. 2A to 2D, and FIGS. 3A and 3B.

FIG. 1A is a block diagram illustrating a structure of an information processing device 200. FIG. 1B schematically illustrates an example of a state where the information processing device 200 is used.

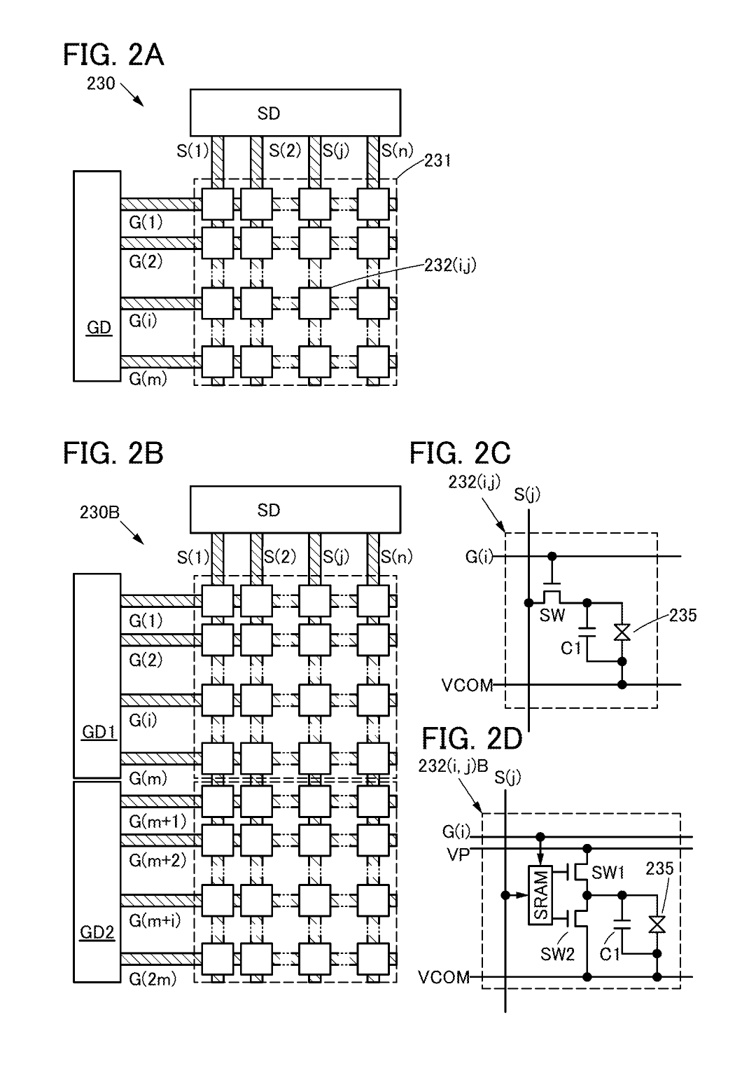

FIG. 2A is a block diagram illustrating a configuration of a display portion 230. FIG. 2B is a block diagram illustrating a configuration of a display portion 230B. FIG. 2C is a circuit diagram illustrating a configuration of a pixel 232(i, j). FIG. 2D is a circuit diagram illustrating a configuration of a pixel 232B(i, j).

### <Configuration Example 1 of Information Processing Device>

The information processing device 200 described in this embodiment includes an arithmetic device 210 and an input/output device 220 (see FIG. 1A).

The arithmetic device 210 is configured to receive positional information P1 and supply image information V1 and control information.

The input/output device 220 is configured to supply the positional information P1 and receive the image information V1 and the control information.

The input/output device 220 includes the display portion 230 that displays the image information V1 and an input portion 240 that supplies the positional information P1.

The display portion 230 includes a reflective liquid crystal element and a pixel circuit electrically connected to the liquid crystal element. The pixel circuit includes a transistor including an oxide semiconductor.

The input portion 240 is configured to detect the position of a pointer and supply the positional information P1 determined in accordance with the position.

The arithmetic device 210 is configured to determine the moving speed of the pointer in accordance with the positional information P1.

The arithmetic device 210 is configured to determine the contrast or brightness of the image information V1 in accordance with the moving speed.

The information processing device 200 described in this embodiment includes the input/output device 220 that supplies the positional information P1 and receives the image information and the arithmetic device 210 that receives the positional information P1 and supplies the image information V1. The arithmetic device 210 is configured to determine the contrast or brightness of the image information V1 in accordance with the moving speed of the positional information P1.

With this structure, eyestrain on a user caused when the display position of image information is moved can be reduced, that is, eye-friendly display can be achieved. Moreover, the power consumption can be reduced and excellent visibility can be provided even in a bright place exposed to direct sunlight, for example. Thus, the novel information processing device that is highly convenient or reliable can be provided.

### <Configuration>

The information processing device of one embodiment of the present invention includes the arithmetic device 210 and the input/output device 220.

### <<Arithmetic Device 210>>

The arithmetic device 210 includes an arithmetic portion 211 and a memory portion 212. The arithmetic device 210 further includes a transmission path 214 and an input/output interface 215 (see FIG. 1A).

### <<Arithmetic Portion 211>>

The arithmetic portion 211 is configured to, for example, execute a program.

### <<Memory Portion 212>>

The memory portion 212 is configured to, for example, store the program executed by the arithmetic portion 211, initial information, setting information, an image, or the like.

Specifically, a hard disk, a flash memory, a memory including a transistor including an oxide semiconductor, or the like can be used for the memory portion 212.

### <<Input/Output Interface 215, Transmission Path 214>>

The input/output interface 215 includes a terminal or a wiring and is configured to supply and receive information. For example, the input/output interface 215 can be electrically connected to the transmission path 214 and the input/output device 220.

The transmission path 214 includes a wiring and is configured to supply and receive information. For example, the transmission path 214 can be electrically connected to the input/output interface 215. In addition, the transmission path 214 can be electrically connected to the arithmetic portion 211 or the memory portion 212.

### <<Input/Output Device 220>>

The input/output device 220 includes the display portion 230, the input portion 240, a sensor portion 250, and a communication portion 290.

### <<Display Portion 230>>

The display portion 230 includes a display region 231, a driver circuit GD, and a driver circuit SD (see FIG. 2A).

The display region 231l includes a plurality of pixels 232(i, 1)to 232(i, n) arranged in the row direction, a plurality of pixels 232(1, j) to 232(m, j) arranged in the column direction, a scan line G(i) electrically connected to the pixels 232(i,1)to 232(i, n), a signal line S(j) electrically connected to the pixels 232(1, j) to 232(m, j), and a wiring VCOM. Note that i is an integer greater than or equal to 1 and less than or equal to m, j is an integer greater than or equal to 1 and less than or equal to n, and each of m and n is an integer greater than or equal to 1.

The display portion can include a plurality of driver circuits. For example, the display portion 230B can include a driver circuit GD1 and a driver circuit GD2 (see FIG. 2B).

### <<Driver Circuit GD>>

The driver circuit GD is configured to supply a selection signal in accordance with the control information.

For example, the driver circuit GD is configured to supply a selection signal to one scan line at a frequency of 30 Hz or higher, preferably 60 Hz or higher, in accordance with the control information. Accordingly, moving images can be smoothly displayed.

For example, the driver circuit GD is configured to supply a selection signal to one scan line at a frequency of lower than 30 Hz, preferably lower than 1 Hz, more preferably less than once per minute, in accordance with the control information. Accordingly, a still image can be displayed while flickering is suppressed.

For example, in the case where a plurality of driver circuits is provided, the driver circuits GD1 and GD2 may supply the selection signals at different frequencies. Specifically, the selection signal can be supplied at a higher frequency to a region on which moving images are smoothly displayed than to a region on which a still image is displayed in a state where flickering is suppressed.

### <<Driver Circuit SD>>

The driver circuit SD is configured to supply an image signal in accordance with the image information V1.

<<Pixel 232(i,j)>>

The pixel 232(i, j). includes a display element 235 and a pixel circuit electrically connected to the display element.

### <<Display Element 235>>

For example, a display element having a function of controlling light transmission can be used as the display element 235. For example, a polarizing plate and a liquid crystal element or a MEMS shutter display element can be used.

Specifically, a liquid crystal element driven in any of the following driving modes can be used: an in-plane-switching (IPS) mode, a twisted nematic (TN) mode, a fringe field switching (FFS) mode, an axially symmetric aligned micro-cell (ASM) mode, an optically compensated birefringence (OCB) mode, a ferroelectric liquid crystal (FLC) mode, an antiferroelectric liquid crystal (AFLC) mode, and the like.

In addition, a liquid crystal element that can be driven by, for example, a vertical alignment (VA) mode such as a multi-domain vertical alignment (MVA) mode, a patterned vertical alignment (PVA) mode, or an advanced super view (ASV) mode can be used.

The display element 235 includes a first electrode, a second electrode, and a liquid crystal layer. The liquid crystal layer contains a liquid crystal material whose orientation is controlled by voltage applied between the first electrode and the second electrode. For example, the orientation of the liquid crystal material can be controlled by an electric field in the thickness direction (also referred to as the vertical direction), the horizontal direction, or the diagonal direction of the liquid crystal layer.

For example, thermotropic liquid crystal, low-molecular liquid crystal, high-molecular liquid crystal, polymer dispersed liquid crystal, ferroelectric liquid crystal, anti-ferroelectric liquid crystal, or the like can be used. These liquid crystal materials exhibit a cholesteric phase, a smectic phase, a cubic phase, a chiral nematic phase, an isotropic phase, or the like depending on conditions. Alternatively, a liquid crystal material that exhibits a blue phase can be used.

### <<Pixel Circuit>>

The configuration of the pixel circuit can be designed according to the display element. For example, the pixel circuit is electrically connected to the scan line G(i), the signal line S(j), and the wiring VCOM.

For example, in the case where a liquid crystal element is used as the display element 235, a capacitor C1, a transistor SW functioning as a switch, and the like can be used in the pixel circuit. Alternatively, for example, a transistor, a diode, a resistor, a capacitor, or an inductor can be used in the pixel circuit.

For example, a plurality of transistors can be used instead of the transistor SW functioning as a switch. Alternatively, a plurality of transistors connected in parallel, in series, or in combination of parallel connection and series connection can be used instead of the transistor SW functioning as a switch.

For example, a capacitor may be formed by the first electrode of the display element 235 and a conductive film having a region overlapping with the first electrode.

For example, the pixel circuit includes the transistor SW functioning as a switch and the capacitor C1. A gate electrode of the transistor SW is electrically connected to the scan line G(i), and a first electrode of the transistor SW is electrically connected to the signal line S(j). A first electrode of the capacitor C1 is electrically connected to a second electrode of the transistor SW, and a second electrode of the capacitor C1 is electrically connected to the wiring VCOM (see FIG. 2C). Note that the first electrode of the display element 235 is electrically connected to the second electrode of the transistor SW functioning as a switch, and the second electrode of the display element 235 is electrically connected to the wiring VCOM.

### <<Transistor>>

For example, a semiconductor film formed at the same step can be used for transistors in the driver circuit and the pixel circuit.

As the transistors in the driver circuit and the pixel circuit, bottom-gate transistors, top-gate transistors, or the like can be used.

For example, a transistor including a semiconductor containing an element of Group 4 can be used. Specifically, a semiconductor containing silicon can be used for a semiconductor film. For example, single crystal silicon, polysilicon, microcrystalline silicon, or amorphous silicon can be used for the semiconductor film of the transistor.

For example, a transistor including an oxide semiconductor can be used. Specifically, an oxide semiconductor containing indium or an oxide semiconductor containing indium, gallium, and zinc can be used for a semiconductor film.

For example, a transistor having a lower leakage current in an off state than a transistor that uses amorphous silicon for a semiconductor film can be used. Specifically, a transistor that uses an oxide semiconductor for a semiconductor film can be used.

A pixel circuit using the transistor that uses an oxide semiconductor for the semiconductor film can hold an image signal for a longer time than a pixel circuit using a transistor that uses amorphous silicon for a semiconductor film. Specifically, the selection signal can be supplied at a frequency of lower than 30 Hz, preferably lower than 1 Hz, more preferably less than once per minute while flickering is suppressed. Consequently, eyestrain on a user of the information processing device can be reduced, and power consumption for driving can be reduced.

Alternatively, for example, a transistor including a compound semiconductor can be used. Specifically, a semiconductor containing gallium arsenide can be used for a semiconductor film.

For example, a transistor including an organic semiconductor can be used. Specifically, an organic semiconductor containing any of polyacenes and graphene can be used for the semiconductor film.

### <<Input Portion 240>>

A variety of human interfaces or the like can be used as the input portion 240 (see FIG. 1A).

For example, a keyboard, a mouse, a touch sensor, a microphone, a camera, or the like can be used as the input portion 240. Note that the input/output device 220 that includes the display portion 230 and a touch sensor having a region overlapping with the display portion 230 can be referred to as a touch panel.

For example, a user can make various gestures (e.g., tap, drag, swipe, and pinch in) using his/her finger as a pointer on the touch panel.

The arithmetic device 210, for example, analyzes information on the position, track, or the like of the finger on the touch panel and determines that a specific gesture is supplied when the analysis results meet predetermined conditions. Therefore, the user can supply a certain operation instruction associated with a certain gesture by using the gesture.

For instance, the user can supply a “scrolling instruction” for changing a portion where image information is displayed by using a gesture of touching and moving his/her finger on the touch panel.

### <<Sensor Portion 250>>

The sensor portion 250 is configured to acquire information P2 by detecting the surrounding state.

For example, a camera, an acceleration sensor, a direction sensor, a pressure sensor, a temperature sensor, a humidity sensor, an illuminance sensor, or a global positioning system (GPS) signal receiving circuit can be used as the sensor portion 250.

### <<Communication Portion 290>>

The communication portion 290 is configured to supply and acquire information to/from a network. For example, the communication portion 290 is configured to communicate a router 12 connected to a local area network (LAN) or the like.

### <<Program>>

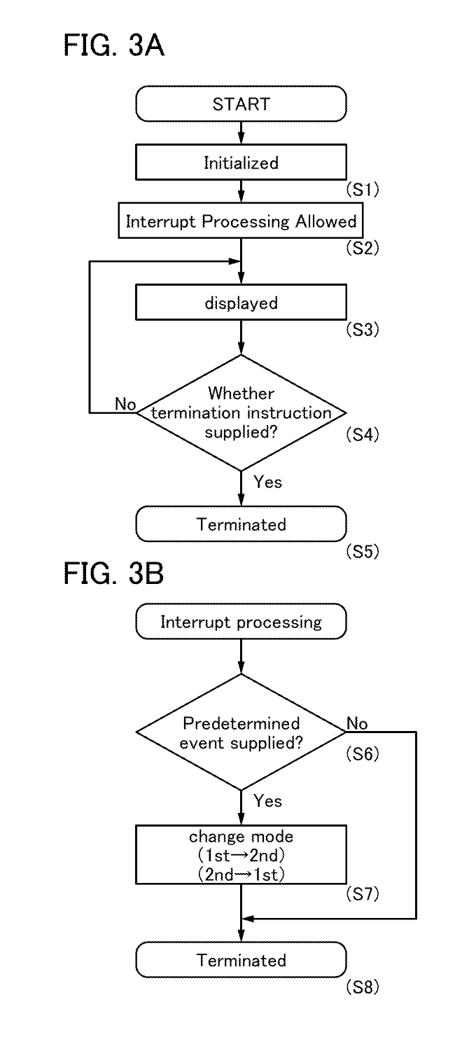

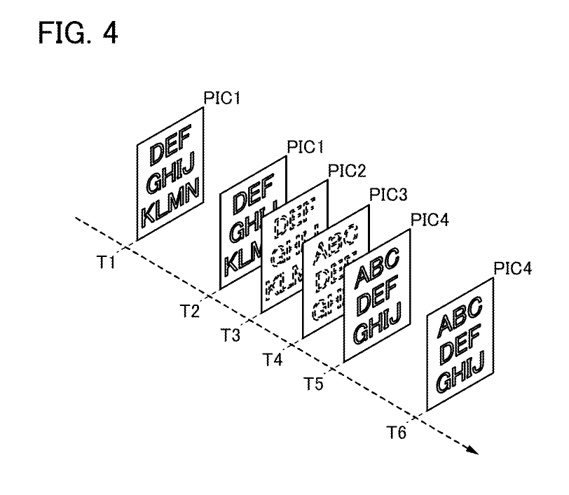

A program of one embodiment of the present invention will be described with reference to FIGS. 3A and 3B and FIG. 4.

FIG. 3A is a flow chart showing main processing of the program of one embodiment of the present invention, and FIG. 3B is a flow chart showing interrupt processing.

FIG. 4 schematically illustrates a method for displaying image information on the display portion 230.

The program of one embodiment of the present invention has the following steps (see FIG. 3A).

In a first step, setting is initialized (see (S1) in FIG. 3A).

For instance, predetermined image information and the second mode can be used for the initialization.

For example, a still image can be used as the predetermined image information. Alternatively, a mode in which the selection signal is supplied at a frequency of lower than 30 Hz, preferably lower than 1 Hz, more preferably less than once per minute can be used as the second mode.

In a second step, interrupt processing is allowed (see S2 in FIG. 3A). Note that an arithmetic device allowed to execute the interrupt processing can perform the interrupt processing in parallel with the main processing. The arithmetic device which has returned from the interrupt processing to the main processing can reflect the results of the interrupt processing in the main processing.

The arithmetic device may execute the interrupt processing when a counter has an initial value, and the counter may be set at a value other than the initial value when the arithmetic device returns from the interrupt processing. Thus, the interrupt processing is ready to be executed after the program is started up.

In a third step, image information is displayed in a mode selected in the first step or the interrupt processing (see S3 in FIG. 3A).

For instance, predetermined image information is displayed in the second mode, in accordance with the initialization.

Specifically, the predetermined image information is displayed in a mode in which the selection signal is supplied to one scan line at a frequency of lower than 30 Hz, preferably lower than 1 Hz, more preferably less than once per minute. For example, the selection signal is supplied at Time T1so that first image information PIC1 is displayed on the display portion 230 (see FIG. 4). At Time T2, which is, for example, one second after Time T1, the selection signal is supplied so that the predetermined image information is displayed.

Alternatively, in the case where a predetermined event is not supplied in the interrupt processing, image information is displayed in the second mode.

For example, the selection signal is supplied at Time T5 so that fourth image information PIC4 is displayed on the display portion 230. At Time T6, which is, for example, one second after Time T5, the selection signal is supplied so that the same image information is displayed. Note that the length of a period from Time T5 to Time T6 can be equal to that of a period from Time T1 to Time T2.

For instance, in the case where the predetermined event is supplied in the interrupt processing, predetermined image information is displayed in the first mode.

Specifically, in the case where an event associated with a “page turning instruction” is supplied in the interrupt processing, image information is switched from one to another in a mode in which the selection signal is supplied to one scan line at a frequency of 30 Hz or higher, preferably 60 Hz or higher.

Alternatively, in the case where an event associated with the “scrolling instruction” is supplied in the interrupt processing, second image information PIC2, which includes part of the displayed first image information PIC1 and the following part, is displayed in a mode in which the selection signal is supplied to one scan line at a frequency of 30 Hz or higher, preferably 60 Hz or higher.

Thus, for example, moving images in which images are gradually switched in accordance with the “page turning instruction” can be displayed smoothly. Alternatively, a moving image in which an image is gradually moved in accordance with the “scrolling instruction” can be displayed smoothly.

Specifically, the selection signal is supplied at Time T3 after the event associated with the “scrolling instruction” is supplied so that the second image information PIC2 whose display position and the like are changed from those of the first image information PIC1 is displayed (see FIG. 4). The selection signal is supplied at Time T4 so that third image information PIC3 whose display position and the like are changed from those of the second image information PIC2 is displayed. Note that each of a period from Time T2 to Time T3, a period from Time T3 to Time T4, and a period from Time T4 to Time T5 is shorter than the period from Time T1 to Time T2.

In the fourth step, the program moves to the fifth step when a termination instruction is supplied, and the program moves to the third step when the termination instruction is not supplied (see S4 in FIG. 3A).

Note that in the interrupt processing, for example, the termination instruction can be supplied.

In the fifth step, the program terminates (see S5 in FIG. 3A).

The interrupt processing includes sixth to eighth steps described below (see FIG. 3B).

In the sixth step, the processing proceeds to the seventh step when a predetermined event has been supplied, whereas the processing proceeds to the eighth step when the predetermined event has not been supplied (see S6 in FIG. 3B).

For example, whether the predetermined event is supplied in a predetermined period or not can be a branch condition. Specifically, the predetermined period can be longer than 0 seconds and shorter than or equal to 5 seconds, preferably shorter than or equal to 1 second, further preferably shorter than or equal to 0.5 seconds, still further preferably shorter than or equal to 0.1 seconds.

For example, the predetermined event can include an event associated with the termination instruction.

In the seventh step, the mode is changed (see S7 in FIG. 3B). Specifically, the mode is changed to the second mode when the first mode has been selected, or the mode is changed to the first mode when the second mode has been selected.

In the eighth step, the interrupt processing terminates (see S8 in FIG. 3B).

### <<Predetermined Event>>

A variety of instructions can be associated with a variety of events.

The following instructions can be given as examples: “page-turning instruction” for switching displayed image information from one to another and “scroll instruction” for moving the display position of part of image information and displaying another part continuing from that part.

For example, the following events can be used: events supplied using a pointing device such as a mouse (e.g., “click” and “drag”) and events supplied to a touch panel with a finger or the like used as a pointer (e.g., “tap”, “drag”, and “swipe”).

For example, the position of a slide bar pointed by a pointer, the swipe speed, and the drag speed can be used as arguments assigned to an instruction associated with the predetermined event.

Specifically, a parameter that determines the page-turning speed or the like can be used to execute the “page-turning instruction,” and a parameter that determines the moving speed of the display position or the like can be used to execute the “scroll instruction.”

For example, the display brightness, contrast, or saturation may be changed in accordance with the page-turning speed and/or the scroll speed.

Specifically, in the case where the page-turning speed and/or the scroll speed are/is higher than the predetermined speed, the display brightness may be decreased in synchronization with the speed.

Alternatively, in the case where the page-turning speed and/or the scroll speed are/is higher than the predetermined speed, the contrast may be decreased in synchronization with the speed.

For example, the speed at which user's eyes cannot follow displayed images can be used as the predetermined speed.

The contrast can be reduced in such a manner that the gray level of a bright region (with a high gray level) included in image information is brought close to the gray level of a dark region (with a low gray level) included in the image information.

Alternatively, the contrast can be reduced in such a manner that the gray level of the dark region included in image information is brought close to the gray level of the bright region included in the image information.

Specifically, in the case where the page-turning speed and/or the scroll speed are/is higher than the predetermined speed, display may be performed such that the yellow tone is increased or the blue tone is decreased in synchronization with the speed.

Image information may be generated based on the usage environment of the information processing device acquired by the sensor portion 250. For example, user's favorite color can be used as the background color of the image information in accordance with the acquired ambient brightness or the like (see FIG. 1B). Thus, favorable environment can be provided for people who make highly creative works that require power of idea or creativity.

For example, information for controlling a lighting 10 may be supplied to a lighting system through the communication portion 290. The lighting system includes the lighting 10, a control device 11 that controls the brightness and color tone of the lighting 10, a LAN connected to the control device 11, and a router 12 connected to the LAN.

Specifically, when a highly creative work that requires power of idea or creativity is made with use of image information displayed on the display portion, a more yellowish or darker color than a background color used when a typical office work or the like is performed efficiently may be used for light of the lighting.

Thus, favorable environment can be provided for a user of the information processing device 200.

Information on power consumed by the information processing device 200 may be supplied to an indicator 13 through the communication portion 290.

### <Configuration Example 2 of Information Processing Device>

A configuration of the pixel 232B(i, j) which can be used in the information processing device of one embodiment of the present invention will be described with reference to FIG. 2D.

Note that the pixel 232B(i, j) in FIG. 2D is different from the pixel 232(i,j). in FIG. 2C in that it includes a transistor SW1 and a transistor SW2 instead of the transistor SW and includes a static memory. In addition, the pixel 232B(i, j) in FIG. 2D is different from the pixel in the display portion 230 in FIG. 2A and the pixel in the display portion 230B in FIG. 2B in that it includes a wiring VP electrically connected to the pixels 232B(i, j) arranged in the row direction.

### <<Pixel Circuit>>

The configuration of the pixel circuit can be designed according to the display element. For example, the pixel circuit is electrically connected to the scan line G(i), the signal line S(j), the wiring VP, and the wiring VCOM.

For example, the pixel circuit includes a static memory SRAM, the transistor SW1, the transistor SW2, and the capacitor C1 (see FIG. 2D).

For example, the static memory SRAM stores information supplied through the signal line S(j), and supplies control information based on the stored information from a first output terminal or a second output terminal. The transistor SW1 or the transistor SW2 supplies a predetermined potential to a first terminal of the display element 235 in accordance with the control information.

In this manner, the state of the display element 235 can be maintained for a longer period than that in a structure without the static memory SRAM. As a result, the frequency of supplying the selection signal can be reduced, which can cut the power consumption and suppress generation of flickering.

A control terminal of the static memory SRAM is electrically connected to the scan line G(i), and an input terminal of the static memory SRAM is electrically connected to the signal line S(j).

A gate of the transistor SW1 is electrically connected to the first output terminal, and a first electrode of the transistor SW1 is electrically connected to the wiring VP. The transistor SW1 functions as a switch.

A gate of the transistor SW2 is electrically connected to the second output terminal, a first electrode of the transistor SW2 is electrically connected to a second electrode of the transistor SW1, and a second electrode of the transistor SW2 is electrically connected to the wiring VCOM. The transistor SW2 functions as a switch.

The first electrode of the display element 235 is electrically connected to the second electrode of the transistor SW1, and the second electrode of the display element 235 is electrically connected to the wiring VCOM.

The first electrode of the capacitor C1 is electrically connected to the second electrode of the transistor SW1, and the second electrode of the capacitor C1 is electrically connected to the wiring VCOM.

### <<Static Memory>>

The static memory stores information supplied through the signal line S(j) in a period in which the static memory receives the selection signal through the scan line G(i), for example. The static memory is configured to supply the control information based on the stored information from the first output terminal or the second output terminal in a period in which the selection signal is not supplied.

For example, a logic circuit using a sequential circuit or the like can be used in the static memory SRAM.

### <<Transistor>>

The transistor SW1 supplies a potential based on the potential of the wiring VP to the first terminal of the display element 235, in accordance with the control information supplied from the first output terminal of the static memory SRAM. Specifically, the transistor SW1 supplies a potential that makes the display element 235 in an operating state.

The transistor SW1 supplies a potential based on the potential of the wiring VCOM to the first terminal of the display element 235, in accordance with the control information supplied from the second output terminal of the static memory SRAM. Specifically, the transistor SW1 supplies a potential that makes the display element 235 in an non-operating state.

Note that the temperature for forming a transistor using polysilicon in a semiconductor film is lower than the temperature for forming a transistor using single crystal silicon in a semiconductor film.

In addition, the transistor using polysilicon in a semiconductor film has higher field-effect mobility than the transistor using amorphous silicon in a semiconductor film, and therefore a pixel including the transistor using polysilicon can have a high aperture ratio. Moreover, pixels arranged at a high density, a gate driver circuit, and a source driver circuit can be formed over the same substrate. As a result, the number of components included in an electronic device can be reduced.

In addition, the transistor using polysilicon in a semiconductor film has higher reliability than the transistor using amorphous silicon in a semiconductor film

This embodiment can be combined with any of the other embodiments in this specification as appropriate.

### Embodiment 2

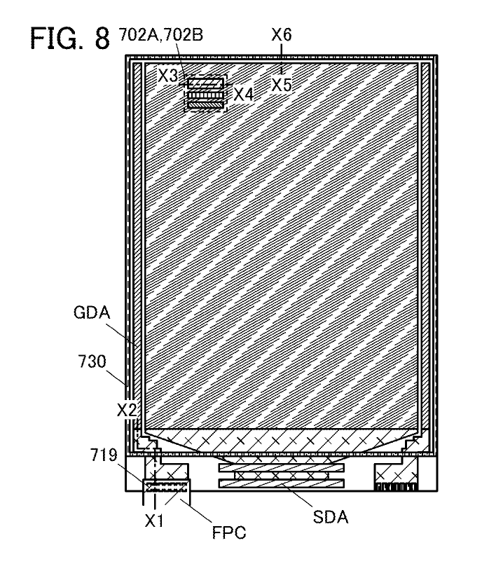

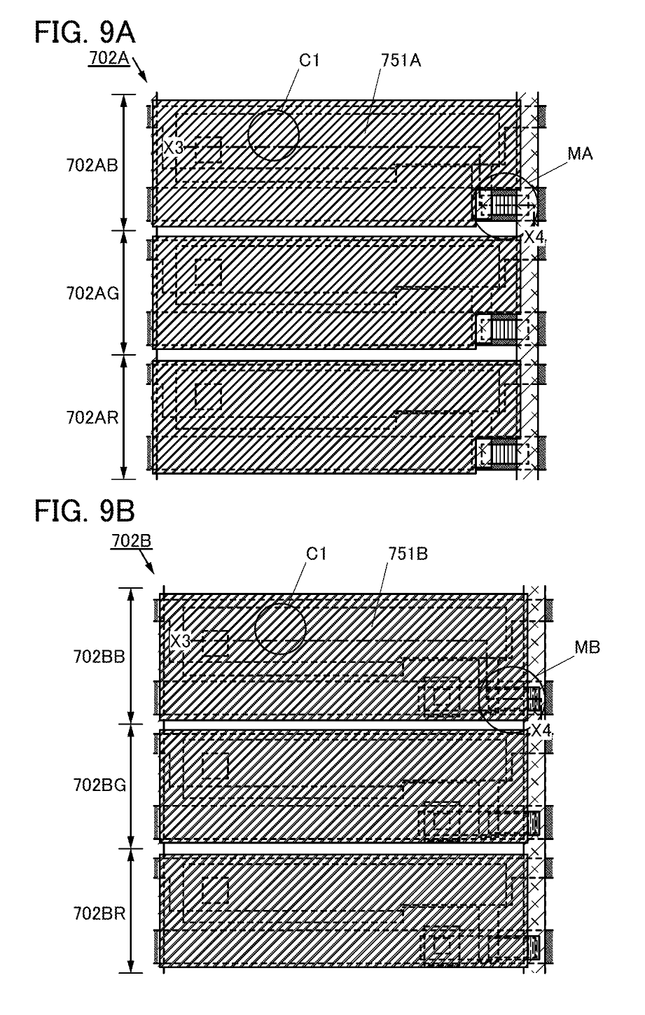

In this embodiment, structures of a display module that can be used in the information processing device of one embodiment of the present invention will be described with reference to FIG. 8, FIGS. 9A and 9B, FIGS. 10A to 10C, and FIGS. 11A and 11B.

Specifically, a structure of a display module 700 that can be used in the display portion 230 in the information processing device 200 of one embodiment of the present invention will be described.

FIG. 8 is a top view illustrating a structure of the display module 700 of one embodiment of the present invention.

FIG. 9A is a top view illustrating a configuration of a pixel 702A in FIG. 8. FIG. 9B illustrates a configuration of a pixel 702B that is different from the pixel 702A in FIG. 8.

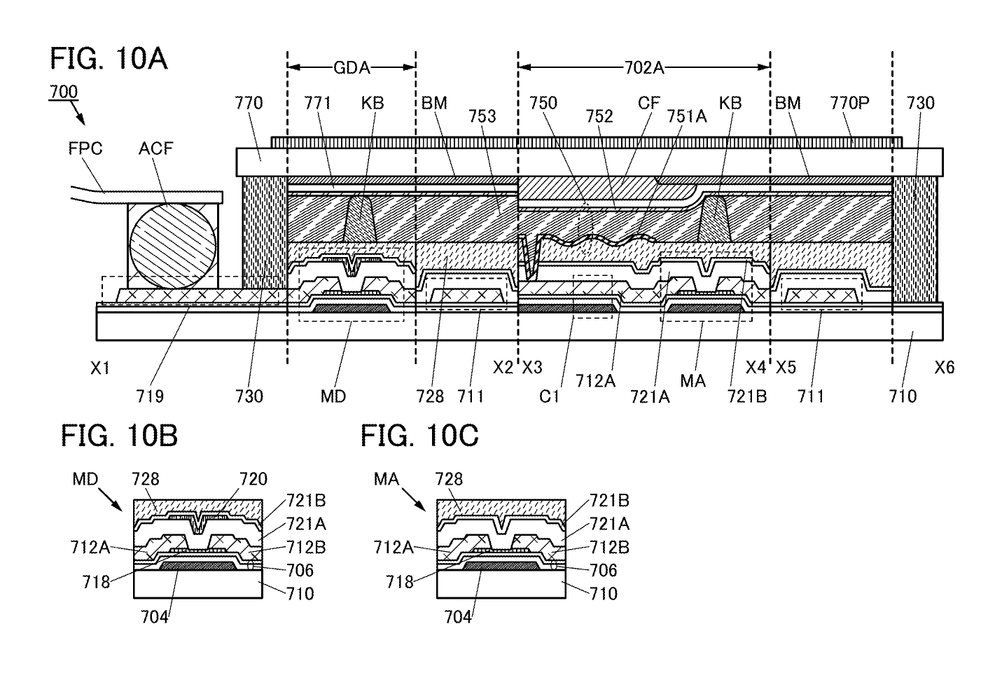

FIG. 10A is a cross-sectional view of the display module 700 in FIG. 8 taken along the lines X1-X2, X3-X4, and X5-X6. FIG. 10B is a cross-sectional view illustrating a structure of the transistor that can be used as a transistor MD. FIG. 10C is a cross-sectional view illustrating a structure of a transistor that can be used as a transistor MA.

### <Structure Example 1 of Display Module>

The display module 700 described in this embodiment includes a pixel portion, a wiring portion, a source driver circuit portion SDA, a gate driver circuit portion GDA, and a terminal portion (see FIG. 8 and FIGS. 10A to 10C).

The display module 700 includes a substrate 710, a substrate 770, a structure body KB, a liquid crystal layer 753, a sealing material 730, and an optical film 770P.

The substrate 770 has a region overlapping with the substrate 710.

The sealing material 730 has a function of bonding the substrate 710 and the substrate 770.

The liquid crystal layer 753 is provided in a region surrounded by the substrate 710, the substrate 770, and the sealing material 730.

The structure body KB is disposed between the substrate 710 and the substrate 770. The structure body KB has a function of keeping a certain distance between the substrate 710 and the substrate 770.

### <<Pixel Portion>>

The pixel portion includes the pixel 702A, a light-blocking film BM, an insulating film 771, an insulating film 721A, an insulating film 721B, and an insulating film 728.

For example, a plurality of subpixels can be used in the pixel 702A. Specifically, a sub-pixel 702AB for displaying blue, a sub-pixel 702AG for displaying green, a sub-pixel 702AR for displaying red, and the like can be used. Moreover, a sub-pixel for displaying white, a sub-pixel for displaying yellow, or the like can be used.

For example, the area of a pixel for displaying blue is larger than the area of a pixel for displaying a color other than blue, which enables favorable white display.

### <<Pixel>>

The pixel 702A includes a liquid crystal element 750, a color film CF, and a pixel circuit (FIGS. 10A to 10C).

### <<Liquid Crystal Element 750>>

For example, the liquid crystal element described in Embodiment 1 can be used as the liquid crystal element 750.

The liquid crystal element 750 includes the liquid crystal layer 753 containing a liquid crystal material, a conductive film 751A, and a conductive film 752. The conductive films 751A and 752 are disposed to apply an electric field for controlling the orientation of the liquid crystal material.

A conductive material can be used for the conductive film 751A.

For example, a material used for the wiring portion can be used for the conductive film 751A or the conductive film 752.

For example, a material that reflects light entering through the liquid crystal layer 753 can be used for the conductive film 751A. In that case, the liquid crystal element 750 can be a reflective liquid crystal element.

For example, a conductive film with an uneven surface can be used as the conductive film 751A. In that case, incident light is reflected in various directions, which enables white display.

For example, a material having a visible-light transmitting property and conductivity can be used for the conductive film 752.

For example, conductive oxide or conductive oxide containing indium can be used for the conductive film 752. Alternatively, a thin metal film that transmits light can be used for the conductive film 752.

Specifically, indium oxide, indium tin oxide, indium zinc oxide, zinc oxide, zinc oxide to which gallium is added, or the like can be used for the conductive film 752.

### <<Color Film CF>>

The color film CF has a region overlapping with the liquid crystal element 750, and has a function of transmitting light of a certain color. The color film CF can be used as a color filter, for example.

For example, a color film CF that transmits blue light can be used for the sub-pixel 702AB; a color film CF that transmits green light can be used for the sub-pixel 702AG; a color film that transmits red light can be used for the sub-pixel 702AR. In addition, a color film CF that transmits white light or a color film CF that transmits yellow light can be used.

### <<Pixel Circuit>>

For example, the transistor MA and the capacitor C1 can be used in the pixel circuit.

The transistor MA includes a semiconductor film 718 and a conductive film 704 having a region overlapping with the semiconductor film 718 (see FIG. 10C). The transistor MA further includes a conductive film 712A and a conductive film 712B.

The conductive film 712A functions as one of a source electrode and a drain electrode, and the conductive film 712B functions as the other of the source electrode and the drain electrode. The conductive film 704 functions as a gate electrode.

For example, a transistor described in Embodiment 3 can be used as the transistor MA.

The capacitor C1 includes the conductive film 712A and a conductive film having a region overlapping with the conductive film 712A (see FIG. 10A).

The conductive film 712A is electrically connected to the conductive film 751A.

### <<Light-Blocking Film BM, Insulating Film>>

The light-blocking film BM has an opening in a region overlapping with the pixel 702A, and has a function of interrupting light transmission. The light-blocking film BM can be used as a black matrix, for example.

The insulating film 771 is disposed between the liquid crystal layer 753 and the light-blocking film BM and between the liquid crystal layer 753 and the color film CF. The insulating film 771 has a function of inhibiting diffusion of impurities contained in the light-blocking film BM, the color film CF, and the like into the liquid crystal layer 753.

The insulating film 721B has a region overlapping with the conductive film 704 and the semiconductor film 718. The insulating film 721A is disposed between the semiconductor film 718 and the insulating film 721B.

The insulating film 728 is disposed between the insulating film 721B and the liquid crystal layer 753.

### <<Source Driver Circuit Portion SDA>>

For example, an integrated circuit can be used for the source driver circuit portion SDA. Specifically, an integrated circuit formed over a silicon substrate can be used (see FIG. 8).

For example, the source driver circuit portion SDA can be mounted on a pad provided in the substrate 710 by a chip on glass (COG) method. Specifically, the integrated circuit can be mounted on the pad with the use of an anisotropic conductive film. Note that the pad is electrically connected to the pixel portion.

### <<Gate Driver Circuit Portion GDA>>

For example, the transistor MD can be used for the gate driver circuit portion GDA (see FIGS. 10A and 10B ).

For example, a transistor described in Embodiment 4 can be used as the transistor MD.

For example, a semiconductor film 718 that is formed at the same step as the semiconductor film 718 included in the transistor MA can be used in the transistor MD.

The transistor MD can have the same structure as the transistor MA.

### <<Conductive Film 720>>

The gate driver circuit portion GDA includes a conductive film 720. The conductive film 720 has a region overlapping with the semiconductor film 718 in the transistor MD. In that case, the semiconductor film 718 can be disposed between the conductive film 704 and the conductive film 720. As a result, the reliability of the transistor MD can be improved.

The conductive film 720 having a region overlapping with the semiconductor film 718 can be used for a second gate electrode of the transistor MD. Therefore, the conductive film 720 can be said to be part of the transistor MD.

For example, a wiring that supplies a potential the same as the potential of the conductive film 704 can be electrically connected to the conductive film 720.

For example, a material used for the wiring portion can be used for the conductive film 720. Specifically, conductive oxide, conductive oxide containing indium, indium oxide, indium tin oxide, indium zinc oxide, indium zinc gallium oxide, zinc oxide, zinc oxide to which gallium is added, or the like can be used for the conductive film 720.

### <<Wiring Portion, Terminal Portion>>

The wiring portion includes a signal line 711, and the terminal portion includes a connection electrode 719 (see FIG. 10A).

The signal line 711 is electrically connected to the connection electrode 719. Part of the signal line 711 can be used for the connection electrode 719.

The connection electrode 719 is electrically connected to a flexible printed substrate FPC with the use of, for example, a conductive member ACF.

A conductive material can be used for the signal line 711 and the connection electrode 719.

For example, an inorganic conductive material, an organic conductive material, a metal material, or a conductive ceramic material can be used for the signal line 711 or the connection electrode 719.

Specifically, a metal element selected from aluminum, gold, platinum, silver, copper, chromium, tantalum, titanium, molybdenum, tungsten, nickel, iron, cobalt, palladium, and manganese, or the like can be used for the signal line 711 or the connection electrode 719. Alternatively, an alloy containing any of the above-described metal elements or the like can be used for the signal line 711 or the connection electrode 719. In particular, an alloy of copper and manganese is suitably used in microfabrication with the use of a wet etching method.

Specifically, a two-layer structure in which a titanium film is stacked over an aluminum film, a two-layer structure in which a titanium film is stacked over a titanium nitride film, a two-layer structure in which a tungsten film is stacked over a titanium nitride film, a two-layer structure in which a tungsten film is stacked over a tantalum nitride film or a tungsten nitride film, a three-layer structure in which a titanium film, an aluminum film, and a titanium film are stacked in this order, or the like can be employed for the signal line 711 or the connection electrode 719.

Specifically, a conductive oxide such as indium oxide, indium tin oxide, indium zinc oxide, zinc oxide, or zinc oxide to which gallium is added can be used for the for the signal line 711 or the connection electrode 719.

Specifically, a film including graphene or graphite can be used for the for the signal line 711 or the connection electrode 719.

For example, a film including graphene oxide is formed and is reduced, so that a film including graphene can be formed. As the reducing method, a method using heat, a method using a reducing agent, or the like can be employed.

Specifically, a conducting polymer can be used for the signal line 711 or the connection electrode 719.

### <<Insulating Film 728>>

For example, an insulating inorganic material, an insulating organic material, or an insulating composite material of an inorganic material and an organic material can be used for the insulating film 728.

Specifically, an inorganic oxide film, an inorganic nitride film, an inorganic oxynitride film, or a stacked film including films selected from these films can be used as the insulating film 728.

Specifically, polyester, polyolefin, polyamide, polyimide, polycarbonate, polysiloxane, an acrylic resin, or a stacked or composite material including resins selected from these, or the like can be used for the insulating film 728. A photosensitive material may be used for the insulating film 728.

The insulating film 728 can eliminate level differences caused by various structures underlying the insulating film 728. Thus, the liquid crystal layer 753 can have a uniform thickness.

### <<Conductive Member>>

For example, solder, a conductive paste, or an anisotropic conductive film can be used for the conductive member ACF.

Specifically, conductive particles, a material that disperses particles, and the like can be used for the conductive member ACF.

For example, a spherical, columnar, or filler particle with a size of greater than or equal to 1 μm and less than or equal to 200 μm, preferably greater than or equal to 3 μm and less than or equal to 150 μm can be used.

For example, a particle covered with a conductive material containing nickel, gold, or the like can be used.

Specifically, a particle comprising polystyrene, an acrylic resin, titanium oxide, or the like can be used.

For example, synthetic rubber, a thermosetting resin, or a thermoplastic resin can be used for the material that disperses particles.

Thus, the flexible printed substrate FPC can be electrically connected to the connection electrode 719 with the use of particles.

### <<Substrate 710>>

A material having heat resistance high enough to withstand heat treatment in the manufacturing process can be used for the substrate 710.

For the substrate 710, an organic material, an inorganic material, a composite material of an organic material and an inorganic material, or the like can be used. For example, an inorganic material such as glass, ceramic, or metal can be used for the substrate 710. Alternatively, paper, wood, or the like can be used for the substrate 710.

Specifically, non-alkali glass, soda-lime glass, potash glass, crystal glass, quartz, sapphire, or the like can be used for the substrate 710. Specifically, an inorganic oxide film, an inorganic nitride film, an inorganic oxynitride film, or the like can be used for the substrate 710. For example, a silicon oxide film, a silicon nitride film, a silicon oxynitride film, or an aluminum oxide film can be used for the substrate 710. Stainless steel, aluminum, or the like can be used for the substrate 710.

For example,a single crystal semiconductor substrate or a polycrystalline semiconductor substrate of silicon or silicon carbide, a compound semiconductor substrate of silicon germanium, or an SOI substrate can be used as the substrate 710. Thus, a semiconductor element can be provided over the substrate 710.

For example, an organic material such as a resin, a resin film, or plastic can be used for the substrate 710. Specifically, a resin film or resin plate of polyester, polyolefin, polyamide, polyimide, polycarbonate, an acrylic resin, or the like can be used for the substrate 710.

For example, a composite material such as a resin film to which a metal plate, a thin glass plate, or a film of an inorganic material is attached can be used for the substrate 710. For example, a composite material formed by dispersing a fibrous or particulate metal, glass, inorganic material, or the like into a resin film can be used for the substrate 710. For example, a composite material formed by dispersing a fibrous or particulate resin, organic material, or the like into an inorganic material can be used for the substrate 710.

Furthermore, a single-layer material or a stacked-layer material in which a plurality of layers are stacked can be used for the substrate 710. For example, a stacked-layer material in which a base, an insulating film that prevents diffusion of impurities contained in the base, and the like are stacked can be used for the substrate 710. Specifically, a stacked-layer material in which glass and one or a plurality of films that prevent diffusion of impurities contained in the glass and that are selected from a silicon oxide layer, a silicon nitride layer, a silicon oxynitride layer, and the like are stacked can be used for the substrate 710. Alternatively, a stacked-layer material in which a resin and a film for preventing diffusion of impurities that penetrate the resin, such as a silicon oxide film, a silicon nitride film, and a silicon oxynitride film are stacked can be used for the substrate 710.

Specifically, a resin film, resin plate, stack, or the like of polyester, polyolefin, polyamide, polyimide, polycarbonate, an acrylic resin, or the like can be used for the substrate 710.

Specifically, a material including polyester, polyolefin, polyamide (e.g., nylon or aramid), polyimide, polycarbonate, an acrylic resin, a urethane resin, an epoxy resin, a resin having a siloxane bond, such as a silicone resin, or the like can be used for the substrate 710.

Specifically, polyethylene terephthalate (PET), polyethylene naphthalate (PEN), polyethersulfone (PES), acrylic, or the like can be used for the substrate 710.

For example, in the case where a glass substrate is used as the substrate 710, a large-sized glass substrate having any of the following sizes can be used: the 6th generation (1500 mm×1850 mm), the 7th generation (1870 mm×2200 mm), the 8th generation (2200 mm×2400 mm), the 9th generation (2400 mm×2800 mm), and the 10th generation (2950 mm×3400 mm). Thus, a large-sized display device can be manufactured.

For example, a flexible substrate can be used as the substrate 710.

Note that a transistor, a capacitor, or the like can be directly formed on the flexible substrate. Alternatively, a transistor, a capacitor, or the like formed on a process substrate having heat resistance can be transferred to a flexible substrate.

### <<Substrate 770>>

A light-transmitting material can be used for the substrate 770. For example, a material that can be used for the substrate 710 can be used for the substrate 770.

The optical film 770P is provided such that the substrate 770 is sandwiched between the liquid crystal layer 753 and the optical film 770P. A polarizing plate or the like can be used as the optical film 770P.

### <Structure Example 2 of Display Module>

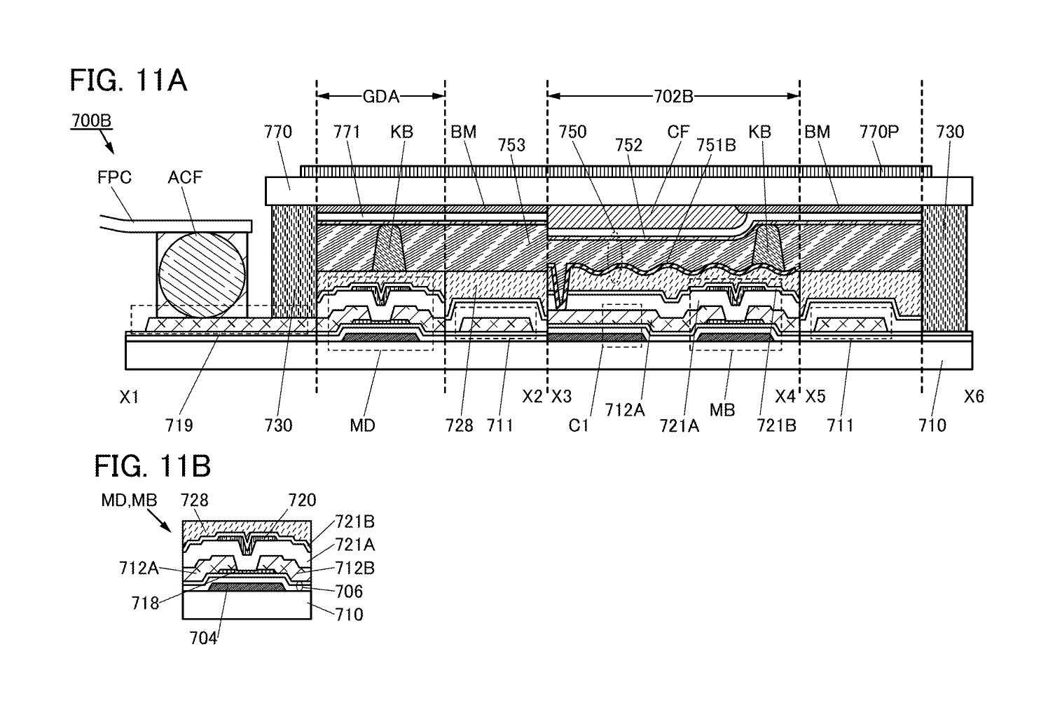

A structure of a display module 700B that can be used in the information processing device of one embodiment of the present invention will be described with reference to FIG. 9B and FIGS. 11A and 11B.

FIG. 9B is a top view illustrating the structure of the display module 700B. The display module 700B has a different structure from the display module 700 in FIG. 9A.

FIG. 11A is a cross-sectional view illustrating the structure of the display module 700B. The display module 700B has a different structure from the display module 700 in FIG. 10A. FIG. 11B is a cross-sectional view illustrating a structure of a transistor that can be used as the transistor MD and the transistor MB.

The display module 700B in FIG. 11A is different from the display module 700 in FIG. 10A in that it includes a sub-pixel 702BB, a sub-pixel 702BG, and a sub-pixel 702BR instead of the sub-pixel 702AB, the sub-pixel 702AG, and the sub-pixel 702AR.

For example, the display module 700B in FIG. 11A is different from the display module 700 in FIG. 10A in that it includes a conductive film 751B having a region overlapping with the transistor MB and includes the conductive film 720 between the conductive film 751B and the semiconductor film 718 of the transistor MB. Different structures will be described in detail below, and the above description is referred to for the other similar structures.

### <<Conductive Film 751B>>

The conductive film 751B has the region overlapping with the transistor MB, which can make the area of the liquid crystal element 750 larger. Therefore, the aperture ratio of the pixel 702B can be higher than that of the pixel 702A.

For example, a material that can be used for the conductive film 751A can be used for the conductive film 751B.

### <<Conductive Film 720>>

The conductive film 720 having a region overlapping with the semiconductor film 718 of the transistor MB is used for the pixel 702B. In that case, the semiconductor film 718 can be disposed between the conductive film 704 and the conductive film 720. As a result, a change in the characteristics of the transistor MB caused by a change in the potential of the conductive film 751B can be suppressed.

The conductive film 720 having a region overlapping with the semiconductor film 718 can be used for a second gate electrode of the transistor MD. Therefore, the conductive film 720 can be said to be part of the transistor MD.

The transistor MB can be formed through the same process as the transistor MD. The transistor MB can have the same structure as the transistor MD.

For example, a wiring that supplies a potential the same as the potential of the conductive film 704 can be electrically connected to the conductive film 720.

For example, a material used for the wiring portion can be used for the conductive film 720. Specifically, conductive oxide, conductive oxide containing indium, indium oxide, indium tin oxide, indium zinc oxide, indium zinc gallium oxide, zinc oxide, zinc oxide to which gallium is added, or the like can be used for the conductive film 720.

For example, a conductive film that can be formed at the same step as the conductive film 720 used for the gate driver circuit portion GDA can be used as the conductive film 720 in the pixel 702B.

### <Structure Example 3 of Display Module>

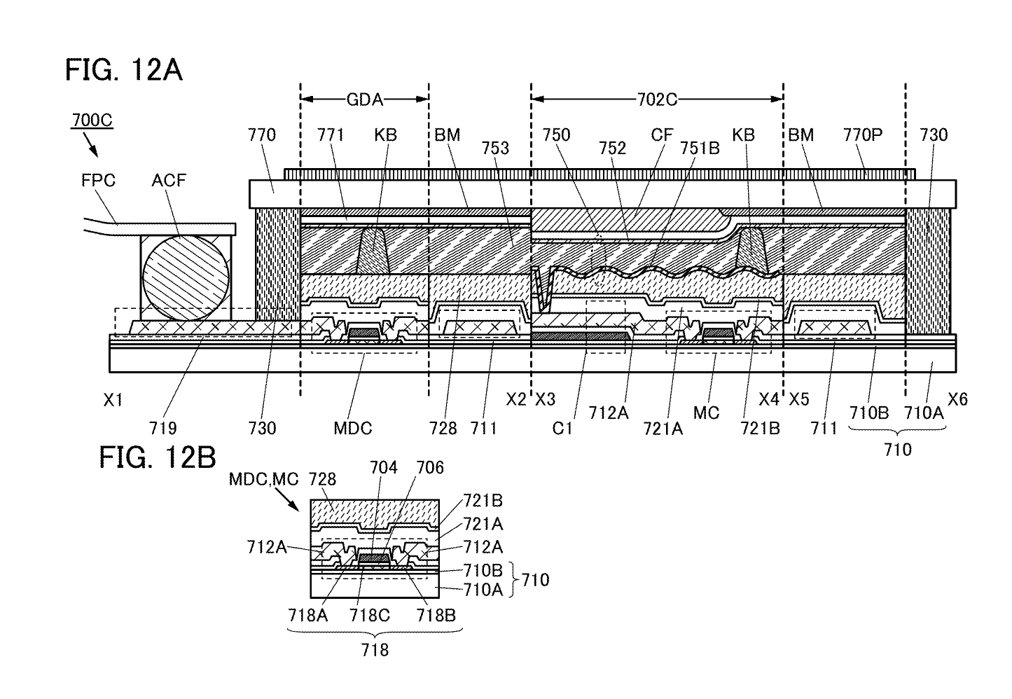

A structure of a display module 700C that can be used in the information processing device of one embodiment of the present invention will be described with reference to FIGS. 12A and 12B.

FIG. 12A is a cross-sectional view illustrating the structure of the display module 700C. The display module 700C has a different structure from the display module 700B in FIG. 11A. FIG. 12B is a cross-sectional view illustrating the structure of the transistor that can be used as a transistor MDC and a transistor MC.

The display module 700C is different from the display module 700B in FIGS. 11A and 11B in that it includes a top-gate transistor instead of a bottom-gate transistor. Different structures will be described in detail below, and the above description is referred to for the other similar structures.

### <<Transistor MC, Transistor MDC>>

The transistor MC includes the conductive film 704 having a region overlapping with an insulating film 710B and the semiconductor film 718 having a region provided between the insulating film 710B and the conductive film 704. Note that the conductive film 704 functions as a gate electrode (see FIG. 12B).

The semiconductor film 718 is consisted of a first region 718A, a second region 718B, and a third region 718C. The first region 718A and the second region 718B do not overlap with the conductive film 704. The third region 718C is positioned between the first region 718A and the second region 718B and overlaps with the conductive film 704.

The transistor MC includes an insulating film 706 between the third region 718C and the conductive film 704. Note that the insulating film 706 functions as a gate insulating film.

The first region 718A and the second region 718B have a lower resistance than the third region 718C, and function as a source region and a drain region.

Note that, for example, a method for controlling the resistivity of the oxide semiconductor film to be described later can be used as a method for forming the first region 718A and the second region 718B in the semiconductor film 718. Specifically, plasma treatment using a gas containing a rare gas can be used. For example, when the conductive film 704 is used as a mask, the shape of part of the third region 718C can be the same as the shape of an end portion of the conductive film 704 in a self-aligned manner.

The transistor MC includes the conductive film 712A in contact with the first region 718A and the conductive film 712B in contact with the second region 718B. The conductive film 712A and the conductive film 712B function as a source electrode and a drain electrode.

A transistor that can be formed in the same process as the transistor MC can be used as the transistor MDC.

### <<Substrate 710>>

For example, a stacked-layer material of a base 710A and the insulating film 710B can be used for the substrate 710. The insulating film 710B has a function of inhibiting diffusion of an impurity from the base 710A into the semiconductor film 718.

### <Method for Controlling Resistivity of Oxide Semiconductor Film>

The method for controlling the resistivity of an oxide semiconductor film will be described.

An oxide semiconductor film with a certain resistivity can be used for the conductive film 720, the first region 718A, or the second region 718B.

For example, a method for controlling the concentration of impurities such as hydrogen and water contained in the oxide semiconductor film and/or the oxygen vacancies in the film can be used as the method for controlling the resistivity of an oxide semiconductor film.

Specifically, plasma treatment can be used as a method for increasing or decreasing the concentration of impurities such as hydrogen and water and/or the oxygen vacancies in the film.

Specifically, plasma treatment using a gas containing one or more kinds selected from a rare gas (He, Ne, Ar, Kr, Xe), hydrogen, and nitrogen can be employed. For example, plasma treatment in an Ar atmosphere, plasma treatment in a mixed gas atmosphere of Ar and hydrogen, plasma treatment in an ammonia atmosphere, plasma treatment in a mixed gas atmosphere of Ar and ammonia, or plasma treatment in a nitrogen atmosphere can be employed. Thus, the oxide semiconductor film can have a high carrier density and a low resistivity.

Alternatively, hydrogen, boron, phosphorus, or nitrogen is added to the oxide semiconductor film by an ion implantation method, an ion doping method, a plasma immersion ion implantation method, or the like, so that the oxide semiconductor film can have a low resistivity.

Alternatively, a method in which an insulating film containing hydrogen is formed in contact with the oxide semiconductor film, and the hydrogen is diffused from the insulating film to the oxide semiconductor film can be used. Thus, the oxide semiconductor film can have a high carrier density and a low resistivity.

For example, an insulating film with a hydrogen concentration of greater than or equal to 1×10²² atoms/cm³ is formed in contact with the oxide semiconductor film, in that case hydrogen can be effectively supplied to the oxide semiconductor film. Specifically, a silicon nitride film can be used as the insulating film formed in contact with the oxide semiconductor film.

Hydrogen contained in the oxide semiconductor film reacts with oxygen bonded to a metal atom to be water, and an oxygen vacancy is formed in a lattice from which oxygen is released (or a portion from which oxygen is released). Due to entry of hydrogen into the oxygen vacancy, an electron serving as a carrier is generated in some cases. Furthermore, bonding of part of hydrogen to oxygen bonded to a metal atom causes generation of an electron serving as a carrier in some cases. Thus, the oxide semiconductor film can have a high carrier density and a low resistivity.

Specifically, an oxide semiconductor with a hydrogen concentration measured by secondary ion mass spectrometry (SIMS) of greater than or equal to 8×10¹⁹ atoms/cm³, preferably greater than or equal to 1×10²⁰ atoms/cm³, more preferably greater than or equal to 5×10²⁰ atoms/cm³ can be suitably used for the conductive film 720.

On the other hand, an oxide semiconductor with a high resistivity can be used for a semiconductor film where a channel of a transistor is formed. Specifically, such an oxide semiconductor can be suitably used for the semiconductor film 718.

For example, an insulating film containing oxygen, in other words, an insulating film capable of releasing oxygen, is formed in contact with an oxide semiconductor film, and the oxygen is supplied from the insulating film to the oxide semiconductor film, so that oxygen vacancies in the film or at the interface can be filled. Thus, the oxide semiconductor film can have a high resistivity.

For example, a silicon oxide film or a silicon oxynitride film can be used as the insulating film capable of releasing oxygen.

The oxide semiconductor film in which oxygen vacancies are filled and the hydrogen concentration is reduced can be referred to as a highly purified intrinsic or substantially highly purified intrinsic oxide semiconductor film. The term “substantially intrinsic” refers to the state in which an oxide semiconductor film has a carrier density lower than 8×10¹¹ /cm³, preferably lower than 1×10¹¹ /cm³, further preferably lower than 1×10¹⁰ /cm³. A highly purified intrinsic or substantially highly purified intrinsic oxide semiconductor film has few carrier generation sources and thus can have a low carrier density. The highly purified intrinsic or substantially highly purified intrinsic oxide semiconductor film has a low density of defect states and accordingly can have a low density of trap states.

Furthermore, a transistor including the highly purified intrinsic or substantially highly purified intrinsic oxide semiconductor film has an extremely low off-state current; even when an element has a channel width W of 1×10⁶ ₗam and a channel length L of 10 ₗam, the off-state current can be lower than or equal to the measurement limit of a semiconductor parameter analyzer, that is, lower than or equal to 1×10⁻¹³ A, at a voltage (drain voltage) between a source electrode and a drain electrode of from 1 V to 10 V.

The transistor in which a channel region is formed in the oxide semiconductor film that is a highly purified intrinsic or substantially highly purified intrinsic oxide semiconductor film can have a small change in electrical characteristics and high reliability.

Specifically, an oxide semiconductor has a hydrogen concentration which is measured by secondary ion mass spectrometry (SIMS) of lower than or equal to 2×10²⁰ atoms/cm³, preferably lower than or equal to 5 ×10¹⁹ atoms/cm³, more preferably lower than or equal to 1×10¹⁹ atoms/cm³, more preferably lower than 5×10¹⁸ atoms/cm³, more preferably lower than or equal to 1×10¹⁸ atoms/cm³, more preferably lower than or equal to 5×10¹⁷ atoms/cm³, more preferably lower than or equal to 1×10¹⁶ atoms/cm³ can be favorably used for a semiconductor film where a channel of a transistor is formed.

An oxide semiconductor film that has a higher hydrogen concentration and/or a larger number of oxygen vacancies and that has a lower resistivity than the semiconductor film 718 is used as the conductive film 720.

A film whose hydrogen concentration is twice or more, preferably ten times or more the hydrogen concentration of the semiconductor film 718 can be used as the conductive film 720.

A film whose resistivity is greater than or equal to 1×10⁻⁸ times and less than 1×10⁻¹ times the resistivity of the semiconductor film 718 can be used as the conductive film 720.

Specifically, a film with a resistivity of greater than or equal to 1×10⁻³ Ωcm and less than 1×10⁴ Ωcm, preferably greater than or equal to 1×10⁻³ Ωcm and less than 1×10⁻¹ Ωcm can be used as the conductive film 720.

### <Structure Example 4 of Display Module>

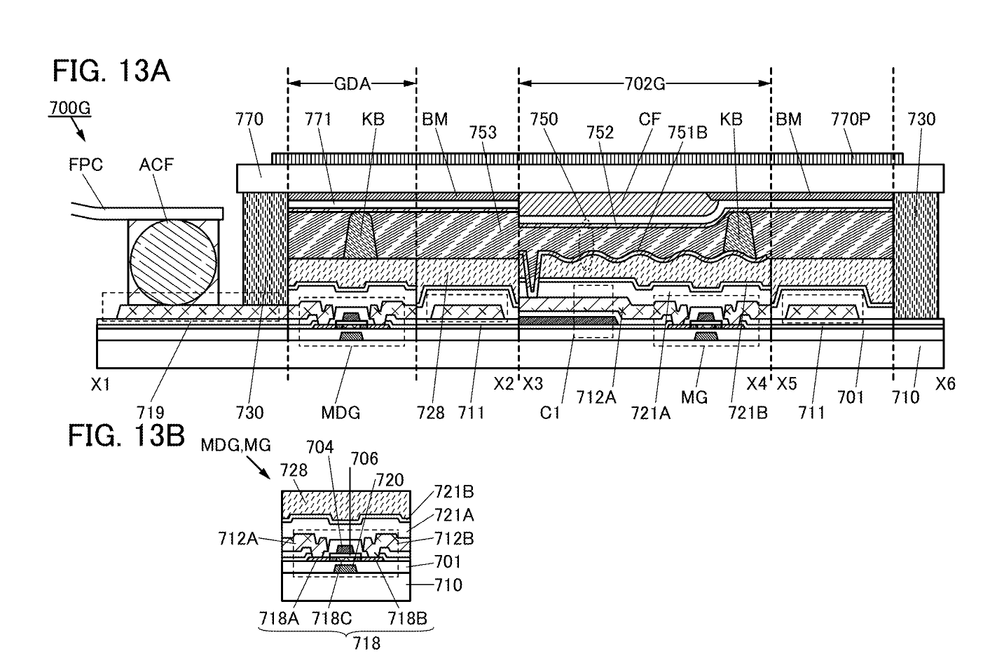

A structure of a display module 700G that can be used in the information processing device of one embodiment of the present invention will be described with reference to FIGS. 13A and 13B.

FIG. 13A is a cross-sectional view illustrating the structure of the display module 700G. FIG. 13B is a cross-sectional view illustrating a structure of a transistor that can be used as a transistor MDG and a transistor MG.

The display module 700G is different from the display module 700B in FIGS. 11A and 11B in that it includes a top-gate transistor instead of a bottom-gate transistor. Different structures will be described in detail below, and the above description is referred to for the other similar structures.

### <<Transistor MG, Transistor MDG>>

The transistor MG includes the conductive film 704 having a region overlapping with an insulating film 701 and the semiconductor film 718 having a region provided between the insulating film 701 and the conductive film 704. Note that the conductive film 704 functions as a gate electrode (see FIG. 13B).

The semiconductor film 718 is consisted of a first region 718A, a second region 718B, and a third region 718C. The first region 718A and the second region 718B do not overlap with the conductive film 704. The third region 718C is positioned between the first region 718A and the second region 718B and overlaps with the conductive film 704.

The transistor MG includes an insulating film 706 between the third region 718C and the conductive film 704. Note that the insulating film 706 functions as a gate insulating film.

The first region 718A and the second region 718B have a lower resistance than the third region 718C, and function as a source region and a drain region.

For example, the resistivity can be reduced by adding an impurity. Specifically, phosphorus, boron, or the like is added by an ion doping method for the reduction in resistivity. For example, when the conductive film 704 is used as a mask, the shape of part of the third region 718C can be the same as the shape of an end portion of the conductive film 704 in a self-aligned manner.

The transistor MG includes the conductive film 712A in contact with the first region 718A and the conductive film 712B in contact with the second region 718B. The conductive film 712A and the conductive film 712B function as a source electrode and a drain electrode.

A transistor that can be formed in the same process as the transistor MG can be used as the transistor MDG.

### <<Insulating Film 701>>

The insulating film 701 has a function of inhibiting diffusion of an impurity from the substrate 710 into the semiconductor film 718. The conductive film 720 having a region overlapping with the semiconductor film 718 can be used as a second gate electrode of the transistor MG. Therefore, the conductive film 720 can be said to be part of the transistor MF. In the case where the conductive film 720 is used as the second gate electrode of the transistor MG, the insulating film 701 functions as a gate insulating film.

This embodiment can be combined with any of the other embodiments in this specification as appropriate.

### Embodiment 3

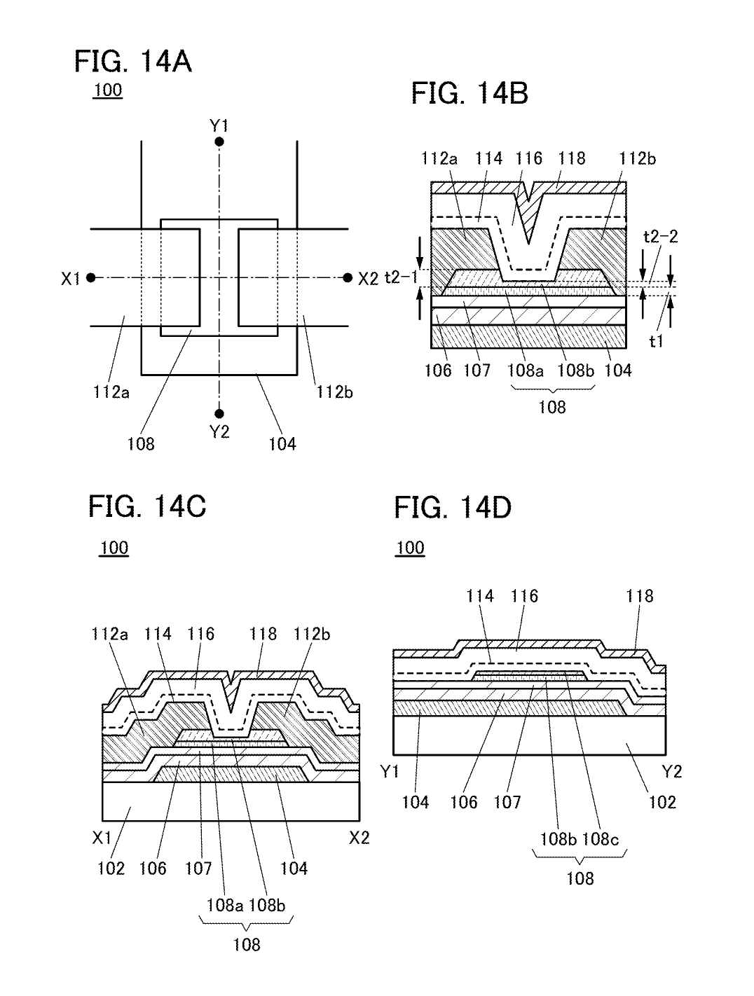

In this embodiment, a structure of a transistor that can be used in the information processing device of one embodiment of the present invention will be described with reference to FIGS. 14A to 14D.

### <Structure Example of Semiconductor Device>

FIG. 14A is a top view of the transistor 100 that can be used in a light-emitting panel of one embodiment of the present invention. FIG. 14C is a cross-sectional view taken along the dashed dotted line X1-X2 in FIG. 14A, and FIG. 14D is a cross-sectional view taken along the dashed dotted line Y1-Y2 in FIG. 14A. FIG. 14B is a cross-sectional enlarged view of the oxide semiconductor film 108 and the vicinity thereof in the transistor 100 illustrated in FIG. 14C. Note that in FIG. 14A, some components of the transistor 100 (e.g., an insulating film serving as a gate insulating film) are not illustrated to avoid complexity. Furthermore, the direction of the dashed dotted line X1-X2 may be called a channel length direction, and the direction of the dashed dotted line Y1-Y2 may be called a channel width direction. As in FIG. 14A, some components are not illustrated in some cases in top views of transistors described below.

For example, the transistor described in this embodiment can be used as the transistor MA of the display module 700 described in Embodiment 2.

For example, when the transistor 100 is used as the transistor MA, a substrate 102, a conductive film 104, a stacked film of an insulating film 106 and an insulating film 107, an oxide semiconductor film 108, a conductive film 112a, a conductive film 112b, a stacked film of an insulating film 114 and an insulating film 116, and an insulating film 118 can be referred to as the substrate 710, the conductive film 704, the insulating film 706, the semiconductor film 718, the conductive film 712A, the conductive film 712B, an insulating film 721A, and the insulating film 721B, respectively.

The transistor 100 includes a conductive film 104 functioning as a gate electrode over a substrate 102, an insulating film 106 over the substrate 102 and the conductive film 104, an insulating film 107 over the insulating film 106, an oxide semiconductor film 108 over the insulating film 107, and conductive films 112a and 112b functioning as source and drain electrodes electrically connected to the oxide semiconductor film 108. Over the transistor 100, specifically, over the conductive films 112a and 112b and the oxide semiconductor film 108, insulating films 114, 116, and 118 are provided. The insulating films 114, 116, and 118 function as protective insulating films for the transistor 100.

The oxide semiconductor film 108 includes an oxide semiconductor film 108a on the conductive film 104 side and an oxide semiconductor film 108b over the oxide semiconductor film 108a. The conductive film 104 serves as a gate electrode. The insulating films 106 and 107 function as gate insulating films of the transistor 100.

In-M oxide (M is Ti, Ga, Sn, Y, Zr, La, Ce, Nd, or Hf) or In-M-Zn oxide can be used for the oxide semiconductor film 108. It is particularly preferable to use In-M-Zn oxide for the oxide semiconductor film 108.

The oxide semiconductor film 108a includes a first region in which the atomic proportion of In is larger than the atomic proportion of M The oxide semiconductor film 108b includes a second region in which the atomic proportion of In is smaller than that in the oxide semiconductor film 108a. The second region includes a portion thinner than the first region.

The oxide semiconductor film 108a including the first region in which the atomic proportion of In is larger than that of M can increase the field-effect mobility (also simply referred to as mobility or μFE) of the transistor 100. Specifically, the field-effect mobility of the transistor 100 can exceed 10 cm²/Vs.

For example, the use of the transistor with high field-effect mobility for a gate driver that generates a gate signal (specifically, a demultiplexer connected to an output terminal of a shift register included in a gate driver) allows a semiconductor device or a display device to have a narrow frame.

On the other hand, the oxide semiconductor film 108a including the first region in which the atomic proportion of In is larger than that of M makes it easier to change electrical characteristics of the transistor 100 in light irradiation. However, in the semiconductor device of one embodiment of the present invention, the oxide semiconductor film 108b is formed over the oxide semiconductor film 108a. In addition, the thickness of the channel region in the oxide semiconductor film 108b is smaller than the thickness of the oxide semiconductor film 108a.

Furthermore, the oxide semiconductor film 108b includes the second region in which the atomic proportion of In is smaller than the oxide semiconductor film 108a and thus has larger Eg than that of the oxide semiconductor film 108a. For this reason, the oxide semiconductor film 108 which is a layered structure of the oxide semiconductor film 108a and the oxide semiconductor film 108b has high resistance to a negative bias stress test with light irradiation.

The amount of light absorbed by the oxide semiconductor film 108 can be reduced during light irradiation. As a result, the change in electrical characteristics of the transistor 100 due to light irradiation can be reduced. In the semiconductor device of one embodiment of the present invention, the insulating film 114 or the insulating film 116 includes excess oxygen. This structure can further reduce the change in electrical characteristics of the transistor 100 due to light irradiation.

Here, the oxide semiconductor film 108 is described in detail with reference to FIG. 14B.

In FIG. 14B, t1, t2-1, and t2-2 denote a thickness of the oxide semiconductor film 108a, one thickness of the oxide semiconductor film 108b, and the other thickness the oxide semiconductor film 108b, respectively. The oxide semiconductor film 108b over the oxide semiconductor film 108a prevents the oxide semiconductor film 108a from being exposed to an etching gas, an etchant, or the like when the conductive films 112a and 112b are formed. This is why the oxide semiconductor film 108a is not or is hardly reduced in thickness. In contrast, in the oxide semiconductor film 108b, a portion not overlapping with the conductive films 112a and 112b is etched by formation of the conductive films 112a and 112b, so that a depression is formed in the etched region. In other words, a thickness of the oxide semiconductor film 108b in a region overlapping with the conductive films 112a and 112b is t2-1, and a thickness of the oxide semiconductor film 108b in a region not overlapping with the conductive films 112a and 112b is t2-2.

As for the relationships between the thicknesses of the oxide semiconductor film 108a and the oxide semiconductor film 108b, t2-1>t1>t2-2 is preferable. A transistor with the thickness relationships can have high field-effect mobility and less variation in threshold voltage in light irradiation.

When oxygen vacancy is formed in the oxide semiconductor film 108 included in the transistor 100, electrons serving as carriers are generated; as a result, the transistor 100 tends to be normally-on. Therefore, for stable transistor characteristics, it is important to reduce oxygen vacancy in the oxide semiconductor film 108 particularly oxygen vacancy in the oxide semiconductor film 108a. In the structure of the transistor of one embodiment of the present invention, excess oxygen is introduced into an insulating film over the oxide semiconductor film 108, here, the insulating film 114 and/or the insulating film 116 over the oxide semiconductor film 108, whereby oxygen is moved from the insulating film 114 and/or the insulating film 116 to the oxide semiconductor film 108 to fill oxygen vacancy in the oxide semiconductor film 108 particularly in the oxide semiconductor film 108a.

It is preferable that the insulating films 114 and 116 each include a region (oxygen excess region) including oxygen in excess of that in the stoichiometric composition. In other words, the insulating films 114 and 116 are insulating films capable of releasing oxygen. Note that the oxygen excess region is formed in the insulating films 114 and 116 in such a manner that oxygen is introduced into the insulating films 114 and 116 after the deposition, for example. As a method for introducing oxygen, an ion implantation method, an ion doping method, a plasma immersion ion implantation method, plasma treatment, or the like may be employed.

In order to fill oxygen vacancy in the oxide semiconductor film 108a, the thickness of the portion including the channel region and the vicinity of the channel region in the oxide semiconductor film 108b is preferably small, and t2-2 21 t1 is preferably satisfied. For example, the thickness of the portion including the channel region and the vicinity of the channel region in the oxide semiconductor film 108b is preferably more than or equal to 1 nm and less than or equal to 20 nm, more preferably more than or equal to 3 nm and less than or equal to 10 nm.

Other constituent elements of the semiconductor device of this embodiment are described below in detail.

### <<Substrate>>

There is no particular limitation on the property of a material and the like of the substrate 102 as long as the material has heat resistance enough to withstand at least heat treatment to be performed later. For example, a glass substrate, a ceramic substrate, a quartz substrate, or a sapphire substrate may be used as the substrate 102.

Alternatively, a single crystal semiconductor substrate or a polycrystalline semiconductor substrate of silicon or silicon carbide, a compound semiconductor substrate of silicon germanium, an SOI substrate, or the like can be used as the substrate 102.

Alternatively, any of these substrates provided with a semiconductor element, an insulating film, or the like may be used as the substrate 102.

In the case where a glass substrate is used as the substrate 102, a large substrate having any of the following sizes can be used: the 6th generation (1500 mm×1850 mm), the 7th generation (1870 mm×2200 mm), the 8th generation (2200 mm×2400 mm), the 9th generation (2400 mm×2800 mm), and the 10th generation (2950 mm×3400 mm). Thus, a large display device can be manufactured.

Alternatively, a flexible substrate may be used as the substrate 102, and the transistor 100 may be provided directly on the flexible substrate. Alternatively, a separation layer may be provided between the substrate 102 and the transistor 100. The separation layer can be used when part or the whole of a semiconductor device formed over the separation layer is separated from the substrate 102 and transferred onto another substrate. In such a case, the transistor 100 can be transferred to a substrate having low heat resistance or a flexible substrate as well.

### <<Conductive Film Functioning as a Gate Electrode and Source and Drain Electrodes>>

The conductive film 104 functioning as a gate electrode and the conductive films 112a and 112b functioning as a source electrode and a drain electrode, respectively, can each be formed using a metal element selected from chromium (Cr), copper (Cu), aluminum (Al), gold (Au), silver (Ag), zinc (Zn), molybdenum (Mo), tantalum (Ta), titanium (Ti), tungsten (W), manganese (Mn), nickel (Ni), iron (Fe), and cobalt (Co); an alloy including any of these metal element as its component; an alloy including a combination of any of these metal elements; or the like.

Furthermore, the conductive films 104, 112a, and 112b may have a single-layer structure or a stacked-layer structure of two or more layers. For example, a single-layer structure of an aluminum film including silicon, a two-layer structure in which a titanium film is stacked over an aluminum film, a two-layer structure in which a titanium film is stacked over a titanium nitride film, a two-layer structure in which a tungsten film is stacked over a titanium nitride film, a two-layer structure in which a tungsten film is stacked over a tantalum nitride film or a tungsten nitride film, and a three-layer structure in which a titanium film, an aluminum film, and a titanium film are stacked in this order can be given. Alternatively, an alloy film or a nitride film in which aluminum and one or more elements selected from titanium, tantalum, tungsten, molybdenum, chromium, neodymium, and scandium are combined may be used.

The conductive films 104, 112a, and 112b can be formed using a light-transmitting conductive material such as indium tin oxide, indium oxide including tungsten oxide, indium zinc oxide including tungsten oxide, indium oxide including titanium oxide, indium tin oxide including titanium oxide, indium zinc oxide, or indium tin oxide to which silicon oxide is added.

A Cu—X alloy film (Xis Mn, Ni, Cr, Fe, Co, Mo, Ta, or Ti) may be used for the conductive films 104, 112a, and 112b. Use of a Cu—X alloy film enables the manufacturing cost to be reduced because wet etching process can be used in the processing.

### <<Insulating Film Functioning as a Gate Insulating Film>>

As each of the insulating films 106 and 107 functioning as gate insulating films of the transistor 100, an insulating film including at least one of the following films formed by a plasma enhanced chemical vapor deposition (PECVD) method, a sputtering method, or the like can be used: a silicon oxide film, a silicon oxynitride film, a silicon nitride oxide film, a silicon nitride film, an aluminum oxide film, a hafnium oxide film, an yttrium oxide film, a zirconium oxide film, a gallium oxide film, a tantalum oxide film, a magnesium oxide film, a lanthanum oxide film, a cerium oxide film, and a neodymium oxide film. Note that instead of a stacked-layer structure of the insulating films 106 and 107, an insulating film of a single layer formed using a material selected from the above or an insulating film of three or more layers may be used.

The insulating film 106 has a function as a blocking film which inhibits penetration of oxygen. For example, in the case where excess oxygen is supplied to the insulating film 107, the insulating film 114, the insulating film 116, and/or the oxide semiconductor film 108, the insulating film 106 can inhibit penetration of oxygen.

Note that the insulating film 107 that is in contact with the oxide semiconductor film 108 functioning as a channel region of the transistor 100 is preferably an oxide insulating film and preferably includes a region including oxygen in excess of the stoichiometric composition (oxygen-excess region). In other words, the insulating film 107 is an insulating film capable of releasing oxygen. In order to provide the oxygen excess region in the insulating film 107, the insulating film 107 is formed in an oxygen atmosphere, for example. Alternatively, the oxygen excess region may be formed by introduction of oxygen into the insulating film 107 after the deposition. As a method for introducing oxygen, an ion implantation method, an ion doping method, a plasma immersion ion implantation method, plasma treatment, or the like may be employed.

In the case where hafnium oxide is used for the insulating film 107, the following effect is attained. Hafnium oxide has a higher dielectric constant than silicon oxide and silicon oxynitride. Therefore, by using hafnium oxide, the thickness of the insulating film 107 can be made large as compared with the case where silicon oxide is used; thus, leakage current due to tunnel current can be low. That is, it is possible to provide a transistor with a low off-state current. Moreover, hafnium oxide with a crystalline structure has higher dielectric constant than hafnium oxide with an amorphous structure. Therefore, it is preferable to use hafnium oxide with a crystalline structure in order to provide a transistor with a low off-state current. Examples of the crystalline structure include a monoclinic crystal structure and a cubic crystal structure. Note that one embodiment of the present invention is not limited thereto.

In this embodiment, a silicon nitride film is formed as the insulating film 106, and a silicon oxide film is formed as the insulating film 107. The silicon nitride film has a higher dielectric constant than a silicon oxide film and needs a larger thickness for capacitance equivalent to that of the silicon oxide film. Thus, when the silicon nitride film is included in the gate insulating film of the transistor 100, the physical thickness of the insulating film can be increased. This makes it possible to reduce a decrease in withstand voltage of the transistor 100 and furthermore to increase the withstand voltage, thereby reducing electrostatic discharge damage to the transistor 100.

### <<Oxide Semiconductor Film>>

The oxide semiconductor film 108 can be formed using the materials described above. In the case where the oxide semiconductor film 108 includes In-M-Zn oxide, it is preferable that the atomic ratio of metal elements of a sputtering target used for forming the In-M-Zn oxide satisfy In≧M and Zn≧M As the atomic ratio of metal elements of such a sputtering target, In:M:Zn=1:1:1, In:M:Zn=1:1:1.2, In:M:Zn=2:1:3, In:M:Zn=3:1:2, and In:M:Zn=4:2:4.1 are preferable. In the case where the oxide semiconductor film 108 is formed of In-M-Zn oxide, it is preferable to use a target including polycrystalline In-M-Zn oxide as the sputtering target. The use of the target including polycrystalline In-M-Zn oxide facilitates formation of the oxide semiconductor film 108 having crystallinity. Note that the atomic ratios of metal elements in the formed oxide semiconductor film 108 vary from the above atomic ratio of metal elements of the sputtering target within a range of ±40% as an error. For example, when a sputtering target with an atomic ratio of In to Ga and Zn of 4:2:4.1 is used, the atomic ratio of In to Ga and Zn in the oxide semiconductor film 108 may be 4:2:3 or in the vicinity of 4:2:3.

The oxide semiconductor film 108a can be formed using the sputtering target having an atomic ratio of In:M:Zn=2:1:3, In:M:Zn=3:1:2, or In:M:Zn=4:2:4.1. The oxide semiconductor film 108b can be formed using the sputtering target having an atomic ratio of In:M:Zn=1:1:1 or In:M:Zn=1:1:1.2. Note that the atomic ratio of metal elements in a sputtering target used for forming the oxide semiconductor film 108b 6does not necessarily satisfy In≧M and Zn≧M, and may satisfy In≧M and Zn<M, such as In:M:Zn=3:2:1.

The energy gap of the oxide semiconductor film 108 is 2 eV or more, preferably 2.5 eV or more, further preferably 3 eV or more. The use of an oxide semiconductor having a wide energy gap can reduce off-state current of the transistor 100. In particular, an oxide semiconductor film having an energy gap more than or equal to 2 eV, preferably more than or equal to 2 eV and less than or equal to 3.0 eV is preferably used as the oxide semiconductor film 108a, and an oxide semiconductor film having an energy gap more than or equal to 2.5 eV and less than or equal to 3.5 eV is preferably used as the oxide semiconductor film 108b . Furthermore, the oxide semiconductor film 108b preferably has a higher energy gap than that of the oxide semiconductor film 108a.

Each thickness of the oxide semiconductor film 108a and the oxide semiconductor film 108b is more than or equal to 3 nm and less than or equal to 200 nm, preferably more than or equal to 3 nm and less than or equal to 100 nm, more preferably more than or equal to 3 nm and less than or equal to 50 nm. Note that the above-described thickness relationships between them are preferably satisfied.

An oxide semiconductor film with low carrier density is used as the oxide semiconductor film 108b. For example, the carrier density of the oxide semiconductor film 108b is lower than or equal to 1 ×10¹⁷ /cm³, preferably lower than or equal to 1×10¹⁵ /cm³, further preferably lower than or equal to 1×10¹³ /cm³, still further preferably lower than or equal to 1×10¹¹ /cm³.

Note that, without limitation to the compositions and materials described above, a material with an appropriate composition may be used depending on required semiconductor characteristics and electrical characteristics (e.g., field-effect mobility and threshold voltage) of a transistor. Further, in order to obtain required semiconductor characteristics of a transistor, it is preferable that the carrier density, the impurity concentration, the defect density, the atomic ratio of a metal element to oxygen, the interatomic distance, the density, and the like of the oxide semiconductor film 108a and the oxide semiconductor film 108b be set to be appropriate.

Note that it is preferable to use, as the oxide semiconductor film 108a and the oxide semiconductor film 108b, an oxide semiconductor film in which the impurity concentration is low and the density of defect states is low, in which case the transistor can have more excellent electrical characteristics. Here, the state in which the impurity concentration is low and the density of defect states is low (the amount of oxygen vacancy is small) is referred to as “highly purified intrinsic” or “substantially highly purified intrinsic”. A highly purified intrinsic or substantially highly purified intrinsic oxide semiconductor film has few carrier generation sources, and thus can have a low carrier density. Thus, a transistor in which a channel region is formed in the oxide semiconductor film rarely has a negative threshold voltage (is rarely normally on). A highly purified intrinsic or substantially highly purified intrinsic oxide semiconductor film has a low density of defect states and accordingly has few carrier traps in some cases. Further, the highly purified intrinsic or substantially highly purified intrinsic oxide semiconductor film has an extremely low off-state current; even when an element has a channel width W of 1×10⁶ μm and a channel length L of 10 μm, the off-state current can be less than or equal to the measurement limit of a semiconductor parameter analyzer, that is, less than or equal to 1×10⁻¹³ A, at a voltage (drain voltage) between a source electrode and a drain electrode of from 1 V to 10 V.

Accordingly, the transistor in which the channel region is formed in the highly purified intrinsic or substantially highly purified intrinsic oxide semiconductor film can have a small change in electrical characteristics and high reliability. Charges trapped by the trap states in the oxide semiconductor film take a long time to be released and may behave like fixed charges. Thus, the transistor whose channel region is formed in the oxide semiconductor film having a high density of trap states has unstable electrical characteristics in some cases. As examples of the impurities, hydrogen, nitrogen, alkali metal, alkaline earth metal, and the like are given.

Hydrogen included in the oxide semiconductor film reacts with oxygen bonded to a metal atom to be water, and also causes oxygen vacancy in a lattice from which oxygen is released (or a portion from which oxygen is released). Due to entry of hydrogen into the oxygen vacancy, an electron serving as a carrier is generated in some cases. Furthermore, in some cases, bonding of part of hydrogen to oxygen bonded to a metal atom causes generation of an electron serving as a carrier. Thus, a transistor including an oxide semiconductor film which contains hydrogen is likely to be normally on. Accordingly, it is preferable that hydrogen be reduced as much as possible in the oxide semiconductor film 108. Specifically, in the oxide semiconductor film 108, the concentration of hydrogen which is measured by SIMS is lower than or equal to 2×10²⁰ atoms/cm³, preferably lower than or equal to 5×10¹⁹ atoms/cm³, further preferably lower than or equal to 1×10¹⁹ atoms/cm³, further preferably lower than or equal to 5×10¹⁸ atoms/cm³, further preferably lower than or equal to 1×10¹⁸ atoms/cm³, further preferably lower than or equal to 5×10¹⁷ atoms/cm³, and further preferably lower than or equal to 1×10¹⁶ atoms/cm³.

When silicon or carbon that is one of elements belonging to Group 14 is included in the oxide semiconductor film 108a, oxygen vacancy is increased in the oxide semiconductor film 108a, and the oxide semiconductor film 108a becomes an n-type film. Thus, the concentration of silicon or carbon (the concentration is measured by SIMS) in the oxide semiconductor film 108a or the concentration of silicon or carbon (the concentration is measured by SIMS) in the vicinity of an interface with the oxide semiconductor film 108a is set to be lower than or equal to 2×10¹⁸ atoms/cm³, preferably lower than or equal to 2×10¹⁷ atoms/cm³.

In addition, the concentration of alkali metal or alkaline earth metal of the oxide semiconductor film 108a, which is measured by SIMS, is lower than or equal to 1 ×10¹⁸ atoms/cm³, preferably lower than or equal to 2×10¹⁶ atoms/cm³. Alkali metal and alkaline earth metal might generate carriers when bonded to an oxide semiconductor, in which case the off-state current of the transistor might be increased. Therefore, it is preferable to reduce the concentration of alkali metal or alkaline earth metal of the oxide semiconductor film 108a.

Furthermore, when including nitrogen, the oxide semiconductor film 108a easily becomes n-type by generation of electrons serving as carriers and an increase of carrier density. Thus, a transistor including an oxide semiconductor film which contains nitrogen is likely to have normally-on characteristics. For this reason, nitrogen in the oxide semiconductor film is preferably reduced as much as possible; the concentration of nitrogen which is measured by SIMS is preferably set to be, for example, lower than or equal to 5×10¹⁸ atoms/cm³.

Each of the oxide semiconductor films 108a and 108b may have a non-single-crystal structure, for example. The non-single crystal structure includes a c-axis aligned crystalline oxide semiconductor (CAAC-OS), a polycrystalline structure, a microcrystalline structure, or an amorphous structure, for example. Among the non-single crystal structure, the amorphous structure has the highest density of defect states, whereas CAAC-OS has the lowest density of defect states.

### <<Insulating Film Functioning as Protective Insulating Film of Transistor>>

The insulating films 114 and 116 each have a function of supplying oxygen to the oxide semiconductor film 108. The insulating film 118 has a function of a protective insulating film of the transistor 100. The insulating films 114 and 116 include oxygen. Furthermore, the insulating film 114 is an insulating film which can transmit oxygen. The insulating film 114 also functions as a film which relieves damage to the oxide semiconductor film 108 at the time of forming the insulating film 116 in a later step.

A silicon oxide film, a silicon oxynitride film, or the like with a thickness greater than or equal to 5 nm and less than or equal to 150 nm, preferably greater than or equal to 5 nm and less than or equal to 50 nm can be used as the insulating film 114.

In addition, it is preferable that the number of defects in the insulating film 114 be small and typically, the spin density corresponding to a signal that appears at g=2.001 due to a dangling bond of silicon be lower than or equal to 3×10¹⁷ spins/cm³ by electron spin resonance (ESR) measurement. This is because if the density of defects in the insulating film 114 is high, oxygen is bonded to the defects and the amount of oxygen that transmits the insulating film 114 is decreased.

Note that all oxygen entering the insulating film 114 from the outside does not move to the outside of the insulating film 114 and some oxygen remains in the insulating film 114. Furthermore, movement of oxygen occurs in the insulating film 114 in some cases in such a manner that oxygen enters the insulating film 114 and oxygen included in the insulating film 114 moves to the outside of the insulating film 114. When an oxide insulating film which can transmit oxygen is formed as the insulating film 114, oxygen released from the insulating film 116 provided over the insulating film 114 can be moved to the oxide semiconductor film 108 through the insulating film 114.

Note that the insulating film 114 can be formed using an oxide insulating film having a low density of states due to nitrogen oxide. Note that the density of states due to nitrogen oxide can be formed between the energy of the valence band maximum (Eᵥ_{_}ₒₛ) and the energy of the conduction band minimum (E_{c}_{_}ₒₛ) of the oxide semiconductor film. A silicon oxynitride film that releases less nitrogen oxide, an aluminum oxynitride film that releases less nitrogen oxide, and the like can be used as the above oxide insulating film.

Note that a silicon oxynitride film that releases less nitrogen oxide is a film of which the amount of released ammonia is larger than the amount of released nitrogen oxide in TDS analysis; the amount of released ammonia is typically greater than or equal to 1×10¹⁸ /cm³ and less than or equal to 5×10¹⁹ /cm³. Note that the amount of released ammonia is the amount of ammonia released by heat treatment with which the surface temperature of a film becomes higher than or equal to 50° C. and lower than or equal to 650° C., preferably higher than or equal to 50° C. and lower than or equal to 550° C.

Nitrogen oxide (NO_{x;} x is greater than 0 and less than or equal to 2, preferably greater than or equal to 1 and less than or equal to 2), typically NO₂ or NO, forms levels in the insulating film 114, for example. The level is positioned in the energy gap of the oxide semiconductor film 108. Therefore, when nitrogen oxide is diffused to the interface between the insulating film 114 and the oxide semiconductor film 108, an electron is in some cases trapped by the level on the insulating film 114 side. As a result, the trapped electron remains in the vicinity of the interface between the insulating film 114 and the oxide semiconductor film 108; thus, the threshold voltage of the transistor is shifted in the positive direction.

Nitrogen oxide reacts with ammonia and oxygen in heat treatment. Since nitrogen oxide included in the insulating film 114 reacts with ammonia included in the insulating film 116 in heat treatment, nitrogen oxide included in the insulating film 114 is reduced. Therefore, an electron is hardly trapped at the vicinity of the interface between the insulating film 114 and the oxide semiconductor film 108.

By using such an oxide insulating film, the insulating film 114 can reduce the shift in the threshold voltage of the transistor, which leads to a smaller change in the electrical characteristics of the transistor.

Note that in an ESR spectrum at 100 K or lower of the insulating film 114, by heat treatment of a manufacturing process of the transistor, typically heat treatment at a temperature higher than or equal to 300° C. and lower than 350° C., a first signal that appears at a g-factor of greater than or equal to 2.037 and less than or equal to 2.039, a second signal that appears at a g-factor of greater than or equal to 2.001 and less than or equal to 2.003, and a third signal that appears at a g-factor of greater than or equal to 1.964 and less than or equal to 1.966 are observed. The split width of the first and second signals and the split width of the second and third signals that are obtained by ESR measurement using an X-band are each approximately 5 mT. The sum of the spin densities of the first signal that appears at a g-factor of greater than or equal to 2.037 and less than or equal to 2.039, the second signal that appears at a g-factor of greater than or equal to 2.001 and less than or equal to 2.003, and the third signal that appears at a g-factor of greater than or equal to 1.964 and less than or equal to 1.966 is lower than 1×10¹⁸ spins/cm³, typically higher than or equal to 1×10¹⁷ spins/cm³ and lower than 1×10¹⁸ spins/cm³.

In the ESR spectrum at 100 K or lower, the first signal that appears at a g-factor of greater than or equal to 2.037 and less than or equal to 2.039, the second signal that appears at a g-factor of greater than or equal to 2.001 and less than or equal to 2.003, and the third signal that appears at a g-factor of greater than or equal to 1.964 and less than or equal to 1.966 correspond to signals attributed to nitrogen oxide (NOₓ, x is greater than 0 and less than or equal to 2, preferably greater than or equal to 1 and less than or equal to 2). Typical examples of nitrogen oxide include nitrogen monoxide and nitrogen dioxide. In other words, the lower the total spin density of the first signal that appears at a g-factor of greater than or equal to 2.037 and less than or equal to 2.039, the second signal that appears at a g-factor of greater than or equal to 2.001 and less than or equal to 2.003, and the third signal that appears at a g-factor of greater than or equal to 1.964 and less than or equal to 1.966 is, the lower the content of nitrogen oxide in the oxide insulating film is.

The concentration of nitrogen of the above oxide insulating film measured by SIMS is lower than or equal to 6×10²⁰ atoms/cm³.

The above oxide insulating film is formed by a PECVD method at a film surface temperature higher than or equal to 220° C. and lower than or equal to 350° C. using silane and dinitrogen monoxide, whereby a dense and hard film can be formed.

The insulating film 116 is formed using an oxide insulating film that contains oxygen in excess of that in the stoichiometric composition. Part of oxygen is released by heating from the oxide insulating film including oxygen in excess of that in the stoichiometric composition. The oxide insulating film including oxygen in excess of that in the stoichiometric composition is an oxide insulating film of which the amount of released oxygen converted into oxygen atoms is greater than or equal to 1.0×10¹⁹ atoms/cm³, preferably greater than or equal to 3.0×10²⁰ atoms/cm³ in TDS analysis. Note that the temperature of the film surface in the TDS analysis is preferably higher than or equal to 100° C. and lower than or equal to 700° C., or higher than or equal to 100° C. and lower than or equal to 500° C.

A silicon oxide film, a silicon oxynitride film, or the like with a thickness greater than or equal to 30 nm and less than or equal to 500 nm, preferably greater than or equal to 50 nm and less than or equal to 400 nm can be used as the insulating film 116.

It is preferable that the number of defects in the insulating film 116 be small, and typically the spin density corresponding to a signal which appears at g=2.001 due to a dangling bond of silicon be lower than 1.5×10¹⁸ spins/cm³, preferably lower than or equal to 1×10¹⁸ spins/cm³ by ESR measurement. Note that the insulating film 116 is provided more apart from the oxide semiconductor film 108 than the insulating film 114 is; thus, the insulating film 116 may have higher density of defects than the insulating film 114.

Furthermore, the insulating films 114 and 116 can be formed using insulating films formed of the same kinds of materials; thus, a boundary between the insulating films 114 and 116 cannot be clearly observed in some cases. Thus, in this embodiment, the boundary between the insulating films 114 and 116 is shown by a dashed line. Although a two-layer structure of the insulating films 114 and 116 is described in this embodiment, the present invention is not limited to this. For example, a single-layer structure of the insulating film 114 may be employed.

The insulating film 118 includes nitrogen. Alternatively, the insulating film 118 includes nitrogen and silicon. The insulating film 118 has a function of blocking oxygen, hydrogen, water, alkali metal, alkaline earth metal, or the like. It is possible to prevent outward diffusion of oxygen from the oxide semiconductor film 108, outward diffusion of oxygen included in the insulating films 114 and 116, and entry of hydrogen, water, or the like into the oxide semiconductor film 108 from the outside by providing the insulating film 118. A nitride insulating film, for example, can be used as the insulating film 118. The nitride insulating film is formed using silicon nitride, silicon nitride oxide, aluminum nitride, aluminum nitride oxide, or the like. Note that instead of the nitride insulating film having a blocking effect against oxygen, hydrogen, water, alkali metal, alkaline earth metal, and the like, an oxide insulating film having a blocking effect against oxygen, hydrogen, water, and the like may be provided. As the oxide insulating film having a blocking effect against oxygen, hydrogen, water, and the like, an aluminum oxide film, an aluminum oxynitride film, a gallium oxide film, a gallium oxynitride film, an yttrium oxide film, an yttrium oxynitride film, a hafnium oxide film, a hafnium oxynitride film, and the like can be given.

Although the variety of films such as the conductive films, the insulating films, and the oxide semiconductor films which are described above can be formed by a sputtering method or a PECVD method, such films may be formed by another method, e.g., a thermal CVD method. Examples of the thermal CVD method include a metal organic chemical vapor deposition (MOCVD) method and an atomic layer deposition (ALD) method.

A thermal CVD method has an advantage that no defect due to plasma damage is generated since it does not utilize plasma for forming a film.

Deposition by a thermal CVD method may be performed in such a manner that a source gas and an oxidizer are supplied to the chamber at a time so that the pressure in a chamber is set to an atmospheric pressure or a reduced pressure, and react with each other in the vicinity of the substrate or over the substrate.

Deposition by an ALD method may be performed in such a manner that the pressure in a chamber is set to an atmospheric pressure or a reduced pressure, source gases for reaction are sequentially introduced into the chamber, and then the sequence of the gas introduction is repeated. For example, two or more kinds of source gases are sequentially supplied to the chamber by switching respective switching valves (also referred to as high-speed valves). For example, a first source gas is introduced, an inert gas (e.g., argon or nitrogen) or the like is introduced at the same time as or after the introduction of the first gas so that the source gases are not mixed, and then a second source gas is introduced. Note that in the case where the first source gas and the inert gas are introduced at a time, the inert gas serves as a carrier gas, and the inert gas may also be introduced at the same time as the introduction of the second source gas. Alternatively, the first source gas may be exhausted by vacuum evacuation instead of the introduction of the inert gas, and then the second source gas may be introduced. The first source gas is adsorbed on the surface of the substrate to form a first layer; then the second source gas is introduced to react with the first layer; as a result, a second layer is stacked over the first layer, so that a thin film is formed. The sequence of the gas introduction is repeated plural times until a desired thickness is obtained, whereby a thin film with excellent step coverage can be formed. The thickness of the thin film can be adjusted by the number of repetition times of the sequence of the gas introduction; therefore, an ALD method makes it possible to accurately adjust a thickness and thus is suitable for manufacturing a minute FET.

The variety of films such as the conductive films, the insulating films, the oxide semiconductor films, and the metal oxide films in this embodiment can be formed by a thermal CVD method such as an MOCVD method or an ALD method. For example, in the case where an In—Ga—Zn—O film is formed, trimethylindium, trimethylgallium, and dimethylzinc are used. Note that the chemical formula of trimethylindium is In(CH₃)_{3.} The chemical formula of trimethylgallium is Ga(CH₃)_{3.} The chemical formula of dimethylzinc is Zn(CH₃)_{2.} Without limitation to the above combination, triethylgallium (chemical formula: Ga(C₂H₅)₃) can be used instead of trimethylgallium and diethylzinc (chemical formula: Zn(C₂H₅)₂) can be used instead of dimethylzinc.

For example, in the case where a hafnium oxide film is formed by a deposition apparatus using an ALD method, two kinds of gases, that is, ozone (O₃) as an oxidizer and a source gas which is obtained by vaporizing liquid containing a solvent and a hafnium precursor compound (e.g., a hafnium alkoxide or a hafnium amide such as tetrakis(dimethylamide)hafnium (TDMAH)) are used. Note that the chemical formula of tetrakis(dimethylamide)hafnium is Hf[N(CH₃)₂]_{4.} Examples of another material liquid include tetrakis(ethylmethylamide)hafnium.

For example, in the case where an aluminum oxide film is formed by a deposition apparatus using an ALD method, two kinds of gases, e.g., H₂O as an oxidizer and a source gas which is obtained by vaporizing liquid containing a solvent and an aluminum precursor compound (e.g., trimethylaluminum (TMA)) are used. Note that the chemical formula of trimethylaluminum is Al(CH₃)_{3.} Examples of another material liquid include tris(dimethylamide)aluminum, triisobutylaluminum, and aluminum tris(2,2,6,6-tetramethyl-3,5-heptanedionate).

For example, in the case where a silicon oxide film is formed by a deposition apparatus using an ALD method, hexachlorodisilane is adsorbed on a surface where a film is to be formed, chlorine included in the adsorbate is removed, and radicals of an oxidizing gas (e.g., O₂ or dinitrogen monoxide) are supplied to react with the adsorbate.

For example, in the case where a tungsten film is formed using a deposition apparatus using an ALD method, a WF₆ gas and a B₂H₆ gas are sequentially introduced plural times to form an initial tungsten film, and then a WF₆ gas and an H₂ gas are used, so that a tungsten film is formed. Note that an SiH₄ gas may be used instead of a B₂H₆ gas.

For example, in the case where an oxide semiconductor film, e.g., an

In—Ga—Zn—O film is formed using a deposition apparatus using an ALD method, an In(CH₃)₃ gas and an O₃ gas are sequentially introduced plural times to form an InO layer, a GaO layer is formed using a Ga(CH₃)₃ gas and an O₃ gas, and then a ZnO layer is formed using a Zn(CH₃)₂ gas and an O₃ gas. Note that the order of these layers is not limited to this example. A mixed compound layer such as an In—Ga—O layer, an In—Zn—O layer, or a Ga—Zn—O layer may be formed by mixing these gases. Note that although an H₂O gas which is obtained by bubbling water with an inert gas such as Ar may be used instead of an O₃ gas, it is preferable to use an O₃ gas, which does not contain H. Furthermore, instead of an In(CH₃)₃ gas, an In(C₂H₅)₃ gas may be used. Instead of a Ga(CH₃)₃ gas, a Ga(C₂H₅)₃ gas may be used. Furthermore, a Zn(CH₃)₂ gas may be used.

This embodiment can be combined with any of the other embodiments in this specification as appropriate.

### Embodiment 4

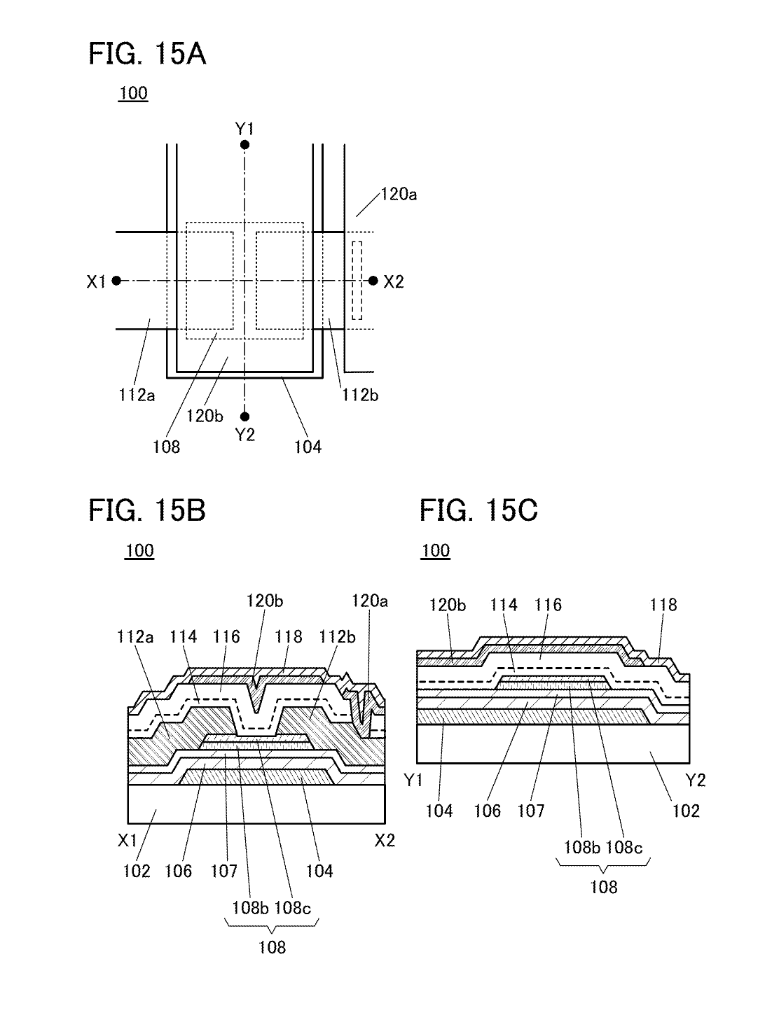

In this embodiment, structures of a transistor that can be used in the information processing device of one embodiment of the present invention will be described with reference to FIGS. 15A to 15C.

### <Structure Example of Semiconductor Device>

FIG. 15A is a top view of the transistor 100. FIG. 15B is a cross-sectional view taken along the dashed dotted line X1-X2 in FIG. 15A, and FIG. 15C is a cross-sectional view taken along the dashed dotted line Y1-Y2 in FIG. 15A. Note that in FIG. 15A, some components of the transistor 100 (e.g., an insulating film serving as a gate insulating film) are not illustrated to avoid complexity. Furthermore, the direction of the dashed dotted line X1-X2 may be called a channel length direction, and the direction of the dashed dotted line Y1-Y2 may be called a channel width direction. As in FIG. 15A, some components are not illustrated in some cases in top views of transistors described below.

The transistor 100 can be used for the display module 700 or the display module 700B described in Embodiment 2.

For example, when the transistor 100 is used as the transistor MB or the transistor MD, the substrate 102, the conductive film 104, a stacked film of the insulating film 106 and the insulating film 107, the oxide semiconductor film 108, the conductive film 112a, the conductive film 112b, a stacked film of the insulating film 114 and the insulating film 116, the insulating film 118, and a conductive film 120b can be referred to as the substrate 710, the conductive film 704, the insulating film 706, the semiconductor film 718, the conductive film 712A, the conductive film 712B, an insulating film 721A, the insulating film 721B, and the conductive film 720, respectively.

The transistor 100 includes a conductive film 104 functioning as a first gate electrode over a substrate 102, an insulating film 106 over the substrate 102 and the conductive film 104, an insulating film 107 over the insulating film 106, an oxide semiconductor film 108 over the insulating film 107, and conductive films 112a and 112b functioning as source and drain electrodes electrically connected to the oxide semiconductor film 108, the insulating films 114 and 116 over the oxide semiconductor film 108 and the conductive films 112a and 112b, a conductive film 120a that is over the insulating film 116 and electrically connected to the conductive film 112b, the conductive film 120b over the insulating film 116, and the insulating film 118 over the insulating film 116 and the conductive films 120a and 120b.

The insulating films 106 and 107 function as a first gate insulating film of the transistor 100. The insulating films 114 and 116 function as a second gate insulating film of the transistor 100. The insulating film 118 functions as a protective insulating film of the transistor 100. In this specification and the like, the insulating films 106 and 107 are collectively referred to as a first insulating film, the insulating films 114 and 116 are collectively referred to as a second insulating film, and the insulating film 118 is referred to as a third insulating film in some cases.

The conductive film 120b can be used as a second gate electrode of the transistor 100.

In the case where the transistor 100 is used in a display panel, the conductive film 120a can be used as an electrode of a display element.

The oxide semiconductor film 108 includes the oxide semiconductor film 108b (on the conductive film 104 side) that functions as a first gate electrode, and an oxide semiconductor film 108c over the oxide semiconductor film 108b. The oxide semiconductor films 108b and 108c contain In, M (M is Al, Ga, Y, or Sn), and Zn.

The oxide semiconductor film 108b preferably includes a region in which the atomic proportion of In is larger than the atomic proportion of M, for example. The oxide semiconductor film 108c preferably includes a region in which the atomic proportion of In is smaller than that in the oxide semiconductor film 108b .

The oxide semiconductor film 108b including the region in which the atomic proportion of In is larger than that of M can increase the field-effect mobility (also simply referred to as mobility or μFE) of the transistor 100. Specifically, the field-effect mobility of the transistor 100 can exceed 10 cm²/Vs, preferably exceed 30 cm²/Vs.

For example, the use of the transistor with high field-effect mobility for a gate driver that generates a gate signal (specifically, a demultiplexer connected to an output terminal of a shift register included in a gate driver) allows a semiconductor device or a display device to have a narrow frame.

On the other hand, the oxide semiconductor film 108b including the region in which the atomic proportion of In is larger than that of M makes it easier to change electrical characteristics of the transistor 100 in light irradiation. However, in the semiconductor device of one embodiment of the present invention, the oxide semiconductor film 108c is formed over the oxide semiconductor film 108b. Furthermore, the oxide semiconductor film 108c including the region in which the atomic proportion of In is smaller than that in the oxide semiconductor film 108b has larger Eg than the oxide semiconductor film 108b. For this reason, the oxide semiconductor film 108 which is a layered structure of the oxide semiconductor film 108b and the oxide semiconductor film 108c has high resistance to a negative bias stress test with light irradiation.

Impurities such as hydrogen or moisture entering the channel region of the oxide semiconductor film 108, particularly the oxide semiconductor film 108b adversely affect the transistor characteristics and therefore cause a problem. Moreover, it is preferable that the amount of impurities such as hydrogen or moisture in the channel region of the oxide semiconductor film 108b be as small as possible. Furthermore, oxygen vacancies formed in the channel region in the oxide semiconductor film 108b adversely affect the transistor characteristics and therefore cause a problem. For example, oxygen vacancies formed in the channel region in the oxide semiconductor film 108b are bonded to hydrogen to serve as a carrier supply source. The carrier supply source generated in the channel region in the oxide semiconductor film 108b causes a change in the electrical characteristics, typically, shift in the threshold voltage, of the transistor 100 including the oxide semiconductor film 108b. Therefore, it is preferable that the amount of oxygen vacancies in the channel region of the oxide semiconductor film 108b be as small as possible.

In view of this, one embodiment of the present invention is a structure in which insulating films in contact with the oxide semiconductor film 108, specifically the insulating film 107 formed under the oxide semiconductor film 108 and the insulating films 114 and 116 formed over the oxide semiconductor film 108 include excess oxygen. Oxygen or excess oxygen is transferred from the insulating film 107 and the insulating films 114 and 116 to the oxide semiconductor film 108, whereby the oxygen vacancies in the oxide semiconductor film can be reduced. As a result, a change in electrical characteristics of the transistor 100, particularly a change in the transistor 100 due to light irradiation, can be reduced.

In one embodiment of the present invention, a manufacturing method is used in which the number of manufacturing steps is not increased or an increase in the number of manufacturing steps is extremely small, because the insulating film 107 and the insulating films 114 and 116 are made to contain excess oxygen. Thus, the transistors 100 can be manufactured with high yield.

Specifically, in a step of forming the oxide semiconductor film 108b, the oxide semiconductor film 108b is formed by a sputtering method in an atmosphere containing an oxygen gas, whereby oxygen or excess oxygen is added to the insulating film 107 over which the oxide semiconductor film 108b is formed.

Furthermore, in a step of forming the conductive films 120a and 120b, the conductive films 120a and 120b are formed by a sputtering method in an atmosphere containing an oxygen gas, whereby oxygen or excess oxygen is added to the insulating film 116 over which the conductive films 120a and 120b are formed. Note that in some cases, oxygen or excess oxygen is added also to the insulating film 114 and the oxide semiconductor film 108 under the insulating film 116 when oxygen or excess oxygen is added to the insulating film 116.

### <Oxide Conductor>

Next, an oxide conductor is described. In a step of forming the conductive films 120a and 120b, the conductive films 120a and 120b serve as a protective film for suppressing release of oxygen from the insulating films 114 and 116. The conductive films 120a and 120b serve as semiconductors before a step of forming the insulating film 118 and serve as conductors after the step of forming the insulating film 118.

To allow the conductive films 120a and 120b to serve as conductors, an oxygen vacancy is formed in the conductive films 120a and 120b and hydrogen is added from the insulating film 118 to the oxygen vacancy, whereby a donor level is formed in the vicinity of the conduction band. As a result, the conductivity of each of the conductive films 120a and 120b is increased, so that the oxide semiconductor film becomes a conductor. The conductive films 120a and 120b having become conductors can each be referred to as oxide conductor. Oxide semiconductors generally have a visible light transmitting property because of their large energy gap. An oxide conductor is an oxide semiconductor having a donor level in the vicinity of the conduction band. Therefore, the influence of absorption due to the donor level is small in an oxide conductor, and an oxide conductor has a visible light transmitting property comparable to that of an oxide semiconductor.

### <Components of the Semiconductor Device>

Components of the semiconductor device of this embodiment will be described below in detail.

As materials described below, materials described in Embodiment 3 can be used.

The material that can be used for the substrate 102 described in Embodiment 3 can be used for the substrate 102 in this embodiment. Furthermore, the materials that can be used for the insulating films 106 and 107 described in Embodiment 3 can be used for the insulating films 106 and 107 in this embodiment.

In addition, the materials that can be used for the conductive films functioning as the gate electrode, the source electrode, and the drain electrode described in Embodiment 3 can be used for the conductive films functioning as the first gate electrode, the source electrode, and the drain electrode in this embodiment.

### <<Oxide Semiconductor Film>>

The oxide semiconductor film 108 can be formed using the materials described above.

In the case where the oxide semiconductor film 108b includes In-M-Zn oxide, it is preferable that the atomic ratio of metal elements of a sputtering target used for forming the In-M-Zn oxide satisfy In>M. The atomic ratio between metal elements in such a sputtering target is, for example, In:M:Zn=2:1:3, In:M:Zn=3:1:2, or In:M:Zn=4:2:4.1.

In the case where the oxide semiconductor film 108c is In-M-Zn oxide, it is preferable that the atomic ratio of metal elements of a sputtering target used for forming a film of the In-M-Zn oxide satisfy In≦M. The atomic ratio of metal elements in such a sputtering target is, for example, In:M:Zn=1:1:1, In:M:Zn=1:1:1.2, In:M:Zn=1:3:2, In:M:Zn=1:3:4, In:M:Zn=1:3:6, or In:M:Zn=1:4:5.

In the case where the oxide semiconductor films 108b and 108c are formed of In-M-Zn oxide, it is preferable to use a target including polycrystalline In-M-Zn oxide as the sputtering target. The use of the target including polycrystalline In-M-Zn oxide facilitates formation of the oxide semiconductor films 108b and 108c having crystallinity. Note that the atomic ratios of metal elements in each of the formed oxide semiconductor films 108b and 108c vary from the above atomic ratio of metal elements of the sputtering target within a range of ±40% as an error. For example, when a sputtering target of the oxide semiconductor film 108b with an atomic ratio of In to Ga and Zn of 4:2:4.1 is used, the atomic ratio of In to Ga and Zn in the oxide semiconductor film 108b may be 4:2:3 or in the vicinity of 4:2:3.

The energy gap of the oxide semiconductor film 108 is 2 eV or more, preferably 2.5 eV or more, further preferably 3 eV or more. The use of an oxide semiconductor having a wide energy gap can reduce off-state current of the transistor 100. In particular, an oxide semiconductor film having an energy gap more than or equal to 2 eV, preferably more than or equal to 2 eV and less than or equal to 3.0 eV is preferably used as the oxide semiconductor film 108b, and an oxide semiconductor film having an energy gap more than or equal to 2.5 eV and less than or equal to 3.5 eV is preferably used as the oxide semiconductor film 108c. Furthermore, the oxide semiconductor film 108c preferably has a higher energy gap than the oxide semiconductor film 108b.

Each thickness of the oxide semiconductor film 108b and the oxide semiconductor film 108c is more than or equal to 3 nm and less than or equal to 200 nm, preferably more than or equal to 3 nm and less than or equal to 100 nm, more preferably more than or equal to 3 nm and less than or equal to 50 nm.

An oxide semiconductor film with low carrier density is used as the oxide semiconductor film 108c. For example, the carrier density of the oxide semiconductor film 108c is lower than or equal to 1×10¹⁷ /cm³, preferably lower than or equal to 1×10¹⁵ /cm³, further preferably lower than or equal to 1×10¹³ /cm³, still further preferably lower than or equal to 1×10¹¹ /cm³.

Note that, without limitation to the compositions and materials described above, a material with an appropriate composition may be used depending on required semiconductor characteristics and electrical characteristics (e.g., field-effect mobility and threshold voltage) of a transistor. Further, in order to obtain required semiconductor characteristics of a transistor, it is preferable that the carrier density, the impurity concentration, the defect density, the atomic ratio of a metal element to oxygen, the interatomic distance, the density, and the like of the oxide semiconductor film 108b and the oxide semiconductor film 108c be set to be appropriate.

Note that it is preferable to use, as the oxide semiconductor film 108b and the oxide semiconductor film 108c, an oxide semiconductor film in which the impurity concentration is low and the density of defect states is low, in which case the transistor can have more excellent electrical characteristics. Here, the state in which the impurity concentration is low and the density of defect states is low (the amount of oxygen vacancy is small) is referred to as “highly purified intrinsic” or “substantially highly purified intrinsic”. A highly purified intrinsic or substantially highly purified intrinsic oxide semiconductor film has few carrier generation sources, and thus can have a low carrier density. Thus, a transistor in which a channel region is formed in the oxide semiconductor film rarely has a negative threshold voltage (is rarely normally on). A highly purified intrinsic or substantially highly purified intrinsic oxide semiconductor film has a low density of defect states and accordingly has few carrier traps in some cases. Further, the highly purified intrinsic or substantially highly purified intrinsic oxide semiconductor film has an extremely low off-state current; even when an element has a channel width W of 1×10⁶ ₗμm and a channel length L of 10 ₗaμ, the off-state current can be less than or equal to the measurement limit of a semiconductor parameter analyzer, that is, less than or equal to 1×10⁻¹³ A, at a voltage (drain voltage) between a source electrode and a drain electrode of from 1 V to 10 V.

Accordingly, the transistor in which the channel region is formed in the highly purified intrinsic or substantially highly purified intrinsic oxide semiconductor film can have a small change in electrical characteristics and high reliability. Charges trapped by the trap states in the oxide semiconductor film take a long time to be released and may behave like fixed charges. Thus, the transistor whose channel region is formed in the oxide semiconductor film having a high density of trap states has unstable electrical characteristics in some cases. As examples of the impurities, hydrogen, nitrogen, alkali metal, and alkaline earth metal are given.

Hydrogen included in the oxide semiconductor film reacts with oxygen bonded to a metal atom to be water, and also causes oxygen vacancy in a lattice from which oxygen is released (or a portion from which oxygen is released). Due to entry of hydrogen into the oxygen vacancy, an electron serving as a carrier is generated in some cases. Furthermore, in some cases, bonding of part of hydrogen to oxygen bonded to a metal atom causes generation of an electron serving as a carrier. Thus, a transistor including an oxide semiconductor film which contains hydrogen is likely to be normally on. Accordingly, it is preferable that hydrogen be reduced as much as possible in the oxide semiconductor film 108. Specifically, in the oxide semiconductor film 108, the concentration of hydrogen which is measured by SIMS is lower than or equal to 2×10²⁰ atoms/cm³, preferably lower than or equal to 5×10¹⁹ atoms/cm³, further preferably lower than or equal to 1×10¹⁹ atoms/cm³, further preferably lower than or equal to 5×10¹⁸ atoms/cm³, further preferably lower than or equal to 1×10¹⁸ atoms/cm³, further preferably lower than or equal to 5×10¹⁷ atoms/cm³, and further preferably lower than or equal to 1×10¹⁶ atoms/cm³.

The oxide semiconductor film 108b preferably includes a region in which hydrogen concentration is smaller than that in the oxide semiconductor film 108c. A semiconductor device including the oxide semiconductor film 108b having the region in which hydrogen concentration is smaller than that in the oxide semiconductor film 108c can be increased in reliability.

When silicon or carbon that is one of elements belonging to Group 14 is included in the oxide semiconductor film 108b, oxygen vacancy is increased in the oxide semiconductor film 108b, and the oxide semiconductor film 108b becomes an n-type film. Thus, the concentration of silicon or carbon (the concentration is measured by SIMS) in the oxide semiconductor film 108b or the concentration of silicon or carbon (the concentration is measured by SIMS) in the vicinity of an interface with the oxide semiconductor film 108b is set to be lower than or equal to 2×10¹⁸ atoms/cm³, preferably lower than or equal to 2×10¹⁷ atoms/cm³.

In addition, the concentration of alkali metal or alkaline earth metal of the oxide semiconductor film 108b, which is measured by SIMS, is lower than or equal to 1 ×10¹⁸ atoms/cm³, preferably lower than or equal to 2×10¹⁶ atoms/cm³. Alkali metal and alkaline earth metal might generate carriers when bonded to an oxide semiconductor, in which case the off-state current of the transistor might be increased. Therefore, it is preferable to reduce the concentration of alkali metal or alkaline earth metal of the oxide semiconductor film 108b.

Furthermore, when including nitrogen, the oxide semiconductor film 108b easily becomes n-type by generation of electrons serving as carriers and an increase of carrier density. Thus, a transistor including an oxide semiconductor film which contains nitrogen is likely to have normally-on characteristics. For this reason, nitrogen in the oxide semiconductor film is preferably reduced as much as possible; the concentration of nitrogen which is measured by SIMS is preferably set to be, for example, lower than or equal to 5×10¹⁸ atoms/cm³.

The oxide semiconductor film 108b and the oxide semiconductor film 108c may have a non-single-crystal structure, for example. The non-single crystal structure includes a c-axis aligned crystalline oxide semiconductor (CAAC-OS), a polycrystalline structure, a microcrystalline structure described later, or an amorphous structure, for example. Among the non-single crystal structure, the amorphous structure has the highest density of defect states, whereas CAAC-OS has the lowest density of defect states.

### <<Insulating Films Functioning as Second Gate Insulating Film>>

The insulating films 114 and 116 function as a second gate insulating film of the transistor 100. In addition, the insulating films 114 and 116 each have a function of supplying oxygen to the oxide semiconductor film 108. That is, the insulating films 114 and 116 contain oxygen. Furthermore, the insulating film 114 is an insulating film which can transmit oxygen. Note that the insulating film 114 also functions as a film which relieves damage to the oxide semiconductor film 108 at the time of forming the insulating film 116 in a later step.

For example, the insulating films 114 and 116 described in Embodiment 3 can be used as the insulating films 114 and 116 in this embodiment.

### <<Oxide Semiconductor Film Functioning as Conductive Film, Oxide Semiconductor Film Functioning as Second Gate Electrode>>

The material of the oxide semiconductor film 108 described above can be used for the conductive film 120a and the conductive film 120b functioning as the second gate electrode.

That is, the conductive film 120a and the conductive film 120b functioning as a second gate electrode contain a metal element which is the same as that contained in the oxide semiconductor film 108 (the oxide semiconductor film 108b and the oxide semiconductor film 108c). For example, the conductive film 120b functioning as a second gate electrode and the oxide semiconductor film 108 (the oxide semiconductor film 108b and the oxide semiconductor film 108c) contain the same metal element; thus, the manufacturing cost can be reduced.

For example, in the case where the conductive film 120a and the conductive film 120b functioning as a second gate electrode are each In-M-Zn oxide, the atomic ratio of metal elements in a sputtering target used for forming the In-M-Zn oxide preferably satisfies In≧M The atomic ratio of metal elements in such a sputtering target is In:M:Zn=2:1:3, InM:Zn=3:1:2, In:M:Zn=4:2:4.1, or the like.

The conductive film 120a and the conductive film 120b functioning as a second gate electrode can each have a single-layer structure or a stacked-layer structure of two or more layers. Note that in the case where the conductive film 120a and the conductive film 120b each have a stacked-layer structure, the composition of the sputtering target is not limited to that described above.

### <<Insulating Film Functioning as Protective Insulating Film of Transistor>>

The insulating film 118 serves as a protective insulating film of the transistor 100.

The insulating film 118 includes one or both of hydrogen and nitrogen. Alternatively, the insulating film 118 includes nitrogen and silicon. The insulating film 118 has a function of blocking oxygen, hydrogen, water, alkali metal, alkaline earth metal, or the like. It is possible to prevent outward diffusion of oxygen from the oxide semiconductor film 108, outward diffusion of oxygen included in the insulating films 114 and 116, and entry of hydrogen, water, or the like into the oxide semiconductor film 108 from the outside by providing the insulating film 118.

The insulating film 118 has a function of supplying one of or both hydrogen and nitrogen to the conductive film 120a and the conductive film 120b functioning as a second gate electrode. The insulating film 118 preferably includes hydrogen and has a function of supplying the hydrogen to the conductive films 120a and 120b. The conductive films 120a and 120b supplied with hydrogen from the insulating film 118 function as conductors.

A nitride insulating film, for example, can be used as the insulating film 118. The nitride insulating film is formed using silicon nitride, silicon nitride oxide, aluminum nitride, aluminum nitride oxide, or the like.

Although the variety of films such as the conductive films, the insulating films, and the oxide semiconductor films which are described above can be formed by a sputtering method or a PECVD method, such films may be formed by another method, e.g., a thermal CVD method. Examples of the thermal CVD method include an MOCVD method and an ALD method. Specifically, the methods described in Embodiment 3 can be used.

This embodiment can be combined with any of the other embodiments in this specification as appropriate.

### Embodiment 5

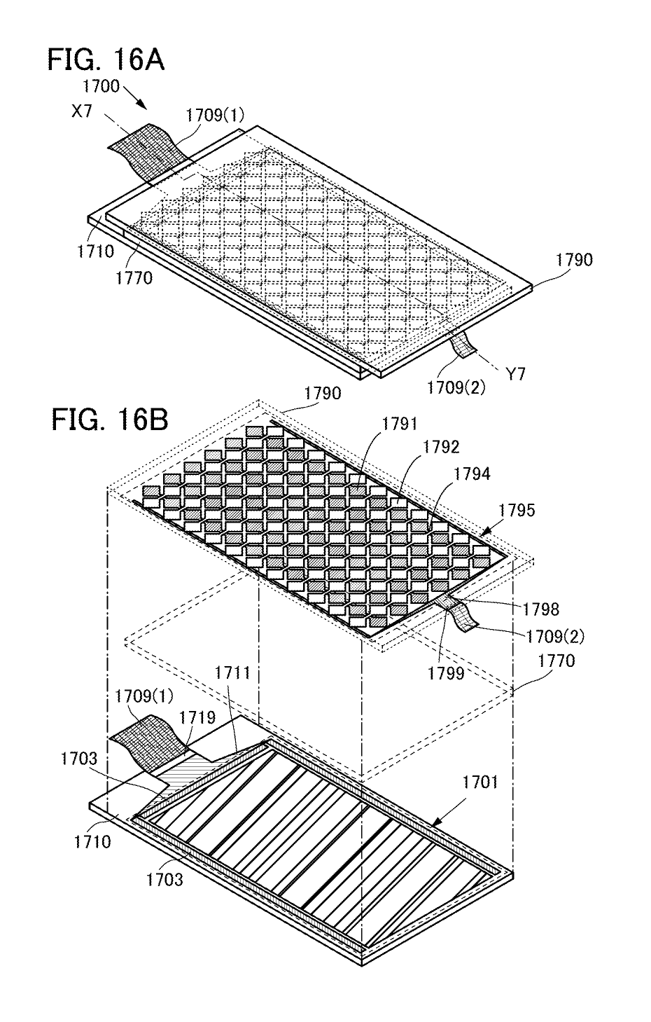

In this embodiment, a structure of a touch panel that includes the element of one embodiment of the present invention will be described with reference to FIGS. 16A and 16B.

FIGS. 16A and 16B are perspective views illustrating a touch panel 1700 described in this embodiment. Note that FIGS. 16A and 16B illustrate only main components for simplicity.

The touch panel 1700 includes a display portion 1701 and a touch sensor 1795 (see FIG. 16B). Furthermore, the touch panel 1700 includes a substrate 1710, a substrate 1770, and a substrate 1790.

The display portion 1701 includes the substrate 1710 and a plurality of pixels and a plurality of wirings 1711 that can supply a signal to the pixels over the substrate 1710. The plurality of wirings 1711 is led to a peripheral portion of the substrate 1710, and part of the plurality of wirings 1711 forms a terminal 1719. The terminal 1719 is electrically connected to an FPC 1709 (1).

### <Touch Sensor>

The substrate 1790 includes the touch sensor 1795 and a plurality of wirings 1798 electrically connected to the touch sensor 1795. The plurality of wirings 1798 is led to a peripheral portion of the substrate 1790, and part of the wirings 1798 forms a terminal. The terminal is electrically connected to an FPC 1709(2). Note that in FIG. 16B, electrodes, wirings, and the like of the touch sensor 1795 provided on the back side of the substrate 1790 (the side facing the substrate 1790) are indicated by solid lines for simplicity.

For example, a capacitive touch sensor can be used as the touch sensor 1795. Examples of the capacitive touch sensor include a surface capacitive touch sensor and a projected capacitive touch sensor.

Examples of the projected capacitive touch sensor include a self-capacitive touch sensor and a mutual capacitive touch sensor, which differ mainly in the driving method. The use of a mutual capacitive touch sensor is preferable because multiple points can be sensed simultaneously.

A case of using a projected capacitive touch sensor will be described below with reference to FIG. 16B.

Note that a variety of sensors that can sense the closeness or the contact of a sensing target such as a finger can be used.

The projected capacitive touch sensor 1795 includes electrodes 1791 and electrodes 1792. The electrodes 1791 are electrically connected to any of the plurality of wirings 1798, and the electrodes 1792 are electrically connected to any of the other wirings 1798.

The electrodes 1792 each have a shape of a plurality of quadrangles arranged in one direction with one corner of a quadrangle connected to one corner of another quadrangle as illustrated in FIGS. 16A and 16B.

The electrodes 1791 each have a quadrangular shape and are arranged in a direction intersecting with the direction in which the electrodes 1792 extend.

A wiring 1794 electrically connects two electrodes 1791 between which the electrode 1792 is positioned. The intersecting area of the electrode 1792 and the wiring 1794 is preferably as small as possible. Such a structure allows a reduction in the area of a region where the electrodes are not provided, reducing unevenness in transmittance. As a result, unevenness in luminance of light transmitted through the touch sensor 1795 can be reduced.

Note that the shapes of the electrode 1791 and the electrode 1792 are not limited thereto and can be any of a variety of shapes. For example, a plurality of electrodes 1791 may be provided so that space between the electrodes 1791 are reduced as much as possible, and a plurality of electrodes 1792 may be provided with an insulating film sandwiched between the electrodes 1791 and the electrodes 1792 and may be spaced apart from each other to form a region not overlapping with the electrodes 1791. In that case, between two adjacent electrodes 1792, it is preferable to provide a dummy electrode which is electrically insulated from these electrodes, whereby the area of a region having a different transmittance can be reduced.

This embodiment can be combined with any of the other embodiments in this specification as appropriate.

### Embodiment 6

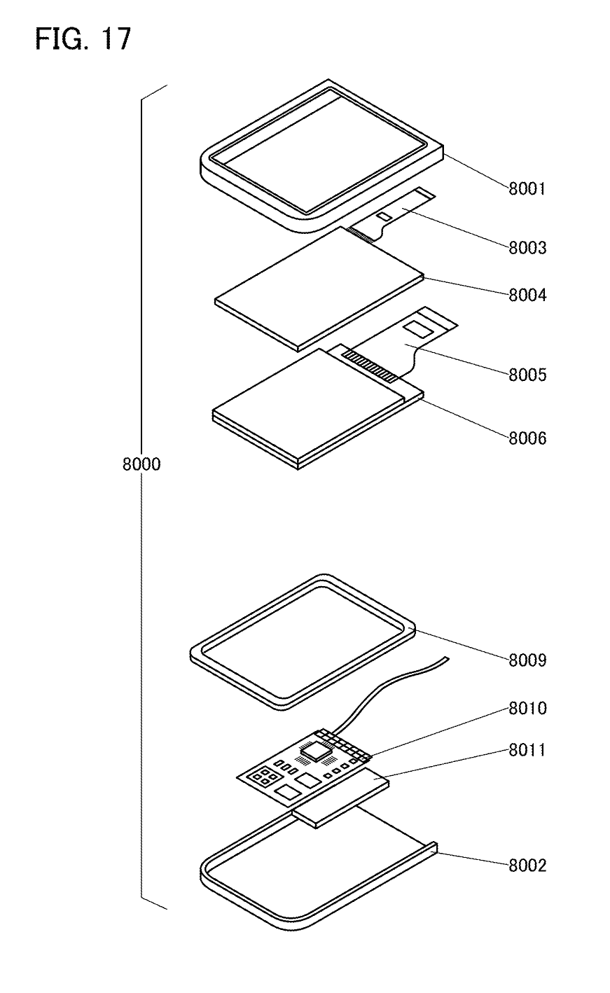

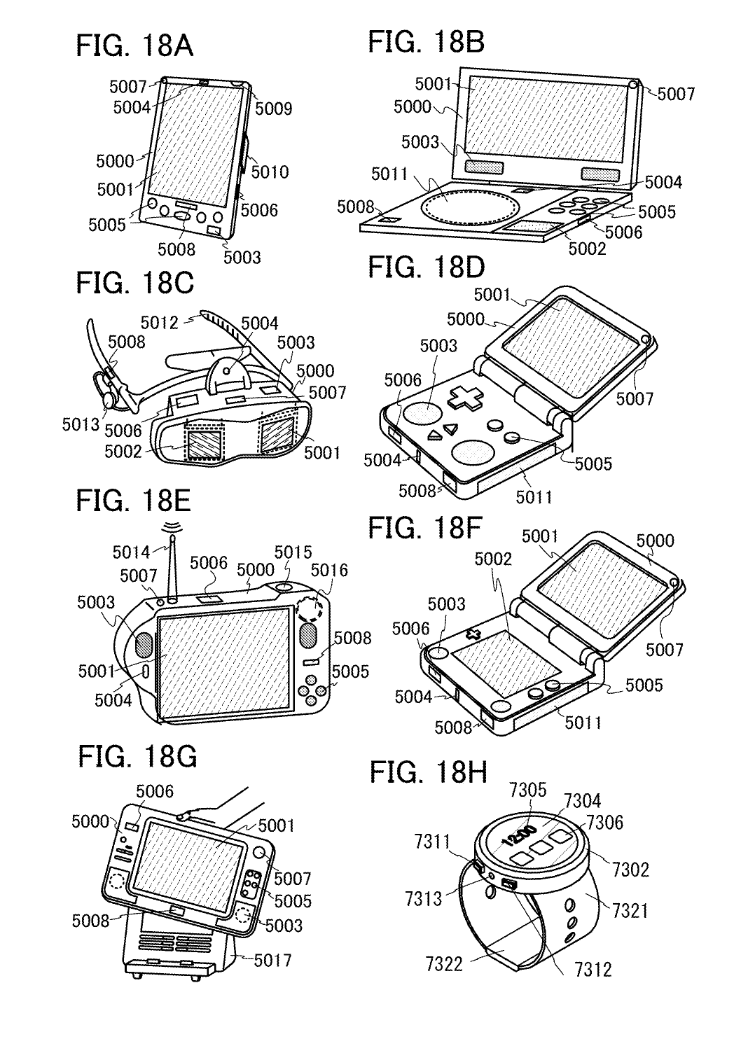

In this embodiment, a display module and electronic devices which include a reflective display device of one embodiment of the present invention will be described with reference to FIG. 17 and FIGS. 18A to 18H.

In a display module 8000 illustrated in FIG. 17, a touch panel 8004 connected to an FPC 8003, a display panel 8006 connected to an FPC 8005, a frame 8009, a printed board 8010, and a battery 8011 are provided between an upper cover 8001 and a lower cover 8002.

The display device of one embodiment of the present invention can be used for, for example, the display panel 8006.

The shapes and sizes of the upper cover 8001 and the lower cover 8002 can be changed as appropriate in accordance with the sizes of the touch panel 8004 and the display panel 8006.

The touch panel 8004 can be a resistive touch panel or a capacitive touch panel and overlap with the display panel 8006. Alternatively, a counter substrate (sealing substrate) of the display panel 8006 can have a touch panel function. Further alternatively, a photosensor can be provided in each pixel of the display panel 8006 to form an optical touch panel.

The frame 8009 protects the display panel 8006 and functions as an electromagnetic shield for blocking electromagnetic waves generated by the operation of the printed board 8010. The frame 8009 can also function as a radiator plate.

The printed board 8010 is provided with a power supply circuit and a signal processing circuit for outputting a video signal and a clock signal. As a power source for supplying power to the power supply circuit, an external commercial power source or the separate battery 8011 may be used. The battery 8011 can be omitted in the case where a commercial power source is used.

The display module 8000 may be provided with an additional member such as a polarizing plate, a retardation plate, or a prism sheet.

FIGS. 18A to 18G illustrate electronic devices. These electronic devices can include a housing 5000, a display portion 5001, a speaker 5003, an LED lamp 5004, operation keys 5005 (including a power switch and an operation switch), a connection terminal 5006, a sensor 5007 (a sensor having a function of measuring force, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared ray), a microphone 5008, and the like.

FIG. 18A illustrates a mobile computer which can include a switch 5009, an infrared port 5010, and the like in addition to the above components. FIG. 18B illustrates a portable image reproducing device (e.g., a DVD reproducing device) provided with a recording medium, and the portable image reproducing device can include a second display portion 5002, a recording medium reading portion 5011, and the like in addition to the above components. FIG. 18C illustrates a goggle-type display which can include the second display portion 5002, a support portion 5012, an earphone 5013, and the like in addition to the above components. FIG. 18D illustrates a portable game console which can include the recording medium reading portion 5011 and the like in addition to the above components. FIG. 18E illustrates a digital camera with a television reception function, and the digital camera can include an antenna 5014, a shutter button 5015, an image receiving portion 5016, and the like in addition to the above components. FIG. 18F illustrates a portable game console which can include the second display portion 5002, the recording medium reading portion 5011, and the like in addition to the above components. FIG. 18G illustrates a portable television receiver which can include a charger 5017 capable of transmitting and receiving signals, and the like in addition to the above components.

The electronic devices in FIGS. 18A to 18G can have a variety of functions such as a function of displaying a variety of information (e.g., a still image, a moving image, and a text image) on the display portion, a touch panel function, a function of displaying a calendar, date, time, and the like, a function of controlling processing with a variety of software (programs), a wireless communication function, a function of being connected to a variety of computer networks with a wireless communication function, a function of transmitting and receiving a variety of data with a wireless communication function, and a function of reading out a program or data stored in a recording medium and displaying it on the display portion. Furthermore, the electronic device including a plurality of display portions can have a function of displaying image information mainly on one display portion while displaying text information mainly on another display portion, a function of displaying a three-dimensional image by displaying images on a plurality of display portions with a parallax taken into account, or the like. Furthermore, the electronic device including an image receiving portion can have a function of shooting a still image, a function of taking moving images, a function of automatically or manually correcting a shot image, a function of storing a shot image in a recording medium (an external recording medium or a recording medium incorporated in the camera), a function of displaying a shot image on the display portion, or the like. Note that functions of the electronic devices in FIGS. 18A to 18G are not limited thereto, and the electronic devices can have a variety of functions.

FIG. 18H illustrates a smart watch, which includes a housing 7302, a display panel 7304, operation buttons 7311 and 7312, a connection terminal 7313, a band 7321, a clasp 7322, and the like.

The display panel 7304 mounted in the housing 7302 serving as a bezel includes a non-rectangular display region. The display panel 7304 may have a rectangular display region. The display panel 7304 can display an icon 7305 indicating time, another icon 7306, and the like.

The smart watch in FIG. 18H can have a variety of functions such as a function of displaying a variety of information (e.g., a still image, a moving image, and a text image) on the display portion, a touch panel function, a function of displaying a calendar, date, time, and the like, a function of controlling processing with a variety of software (programs), a wireless communication function, a function of being connected to a variety of computer networks with a wireless communication function, a function of transmitting and receiving a variety of data with a wireless communication function, and a function of reading out a program or data stored in a recording medium and displaying it on the display portion.

The housing 7302 can include a speaker, a sensor (a sensor having a function of measuring force, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays), a microphone, and the like. Note that the smart watch can be manufactured using the light-emitting element for the display panel 7304.

This embodiment can be combined with any of the other embodiments in this specification as appropriate.

### EXAMPLE

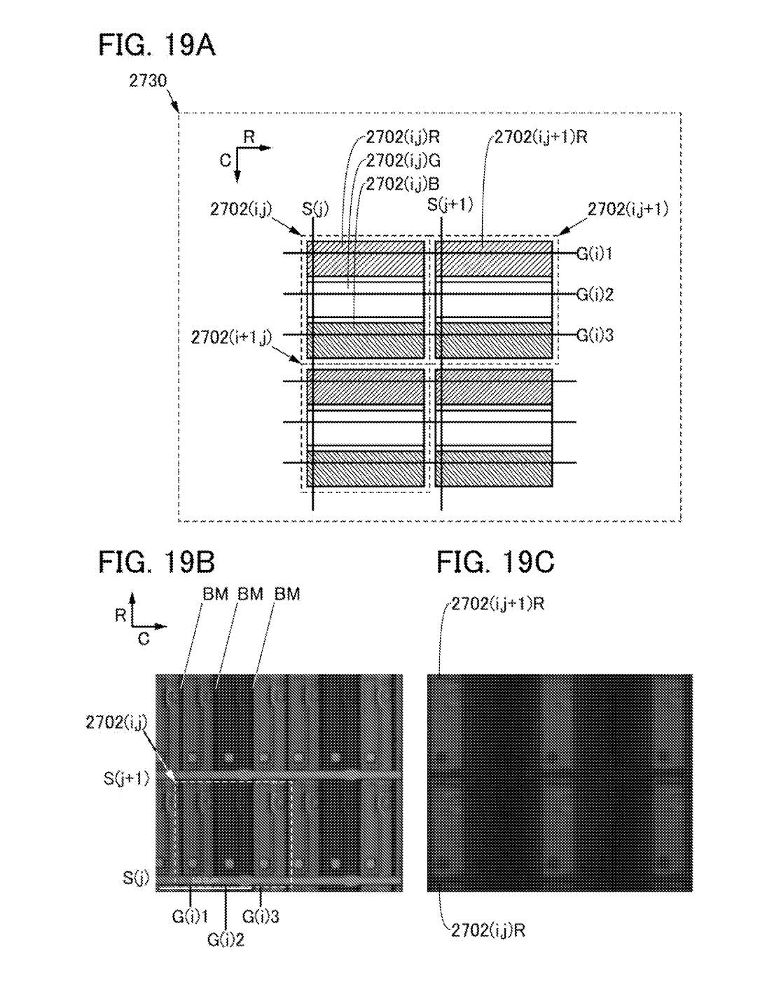

In this example, a fabricated information processing device of one embodiment of the present invention will be described with reference to FIGS. 19A to 19C, FIGS. 20A and 20B, and FIGS. 21A and 21B.

FIGS. 19A to 19C illustrate a display portion 2730 of the information processing device. FIG. 19A illustrates a configuration of the display portion 2730.

FIGS. 19B and 19C are polarizing microscope images of a display state of the display portion 2730.

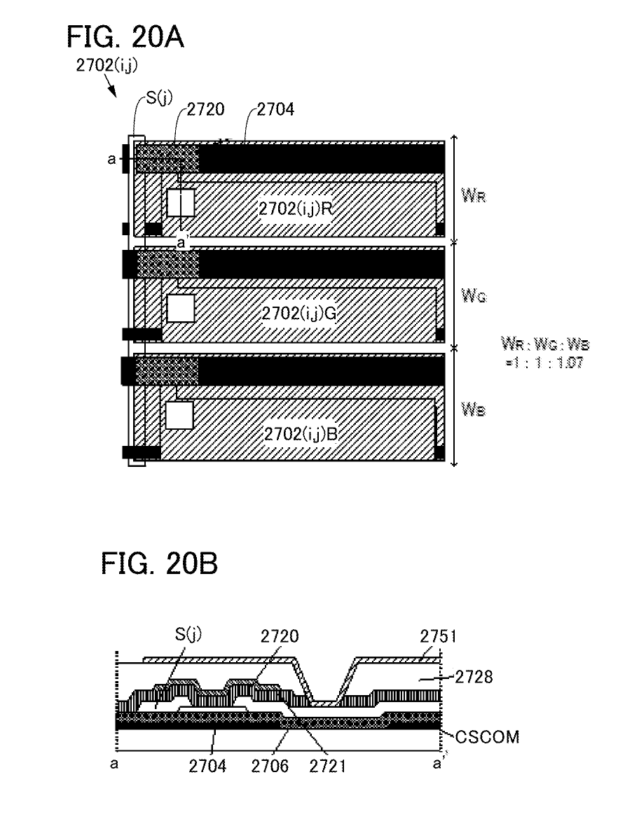

FIGS. 20A and 20B illustrate a configuration of a pixel 2702(i, j). FIG. 20A is a top view illustrating the configuration of the pixel 2702(i, j). FIG. 20B is a cross-sectional view illustrating a configuration of a sub-pixel 2702(i, j)R taken along the line a-a′ in FIG. 20A.

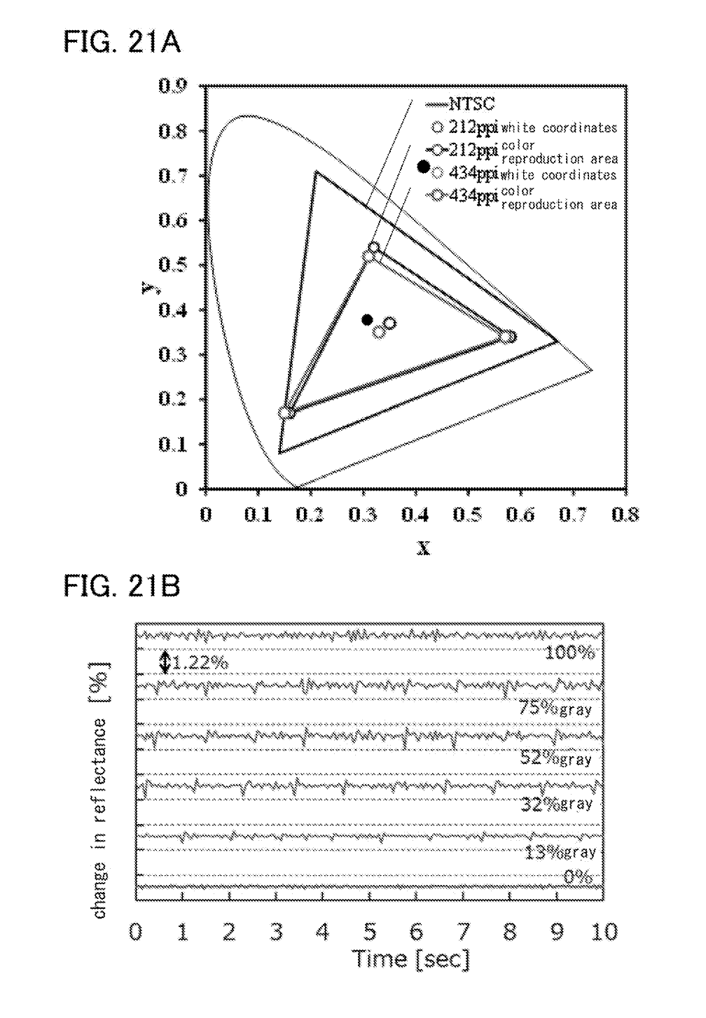

FIGS. 21A and 21B illustrate the characteristics of the information processing device of one embodiment of the present invention. FIG. 21A is a chromaticity diagram showing the range of colors which can be displayed by the fabricated information processing device. FIG. 21B shows measurement results of changes in reflectance with time under the conditions that images with different gray levels are displayed by a method in which the selection signal is supplied at a frequency of 1 Hz. FIG. 21A shows the results of a display portion with a pixel density of 434 ppi and the results of a display portion with a pixel density of 212 ppi.

### <Configuration>

The display portion 2730 of the information processing device described in this example includes the pixel 2702(i, j) and a pixel 2702(i+1, j), a pixel 2702(i, j+1), a scan line G(i)1, a scan line G(i)2, a scan line G(i)3, and a signal line S(j), . In addition, the display portion 2730 includes a signal line S(j+1) (see FIG. 19A).

The pixels 2702(i,j) and 2702(i,j+1) are arranged in the row direction (indicated by an arrow R in FIGS. 19A). The pixels 2702(i,j) and 2702 (1+1,1) are arranged in the column direction (indicated by an arrow C in FIGS. 19A) that intersects with the row direction.

The scan line G(i)1, the scan line G(i)2, and the scan line G(i)3 are electrically connected to the pixels 2702(i,j) and 2702(i+1, j). The signal line S(j) is electrically connected to the pixels 2702(i,j) and 2702(i, j+1).

A group of pixels including the pixels 2702(i,j), 2702(i+1, j), and 2702(i,j+1) are arranged with a pixel density of 434 ppi.

The pixel 2702(i,j) includes the sub-pixel 2702(i,j)R, the sub-pixel 2702(i,j)G, and the sub-pixel 2702(i,j)B (see FIG. 19A and FIG. 20A).

The sub-pixel 2702(i,j)R is electrically connected to the scan line G(i)1 and the signal line S(j), . The sub-pixel 2702(i,j)G is electrically connected to the scan line G(i)2 and the signal line S(j), . The sub-pixel 2702(i,j)B is electrically connected to the scan line G(i)3 and the signal line S(j), .

The pixel 2702(i,j+1) includes the sub-pixel 2702(i,j+1)R. The sub-pixel 2702(i, j+1)R is electrically connected to the scan line G(i)1 and the signal line S(j+1).

The sub-pixel 2702(i,j)G has the same area as the sub-pixel 2702(i,j)R. The sub-pixel 2702(i,j)B has an area 1.07 times the area of the sub-pixel 2702(i,j)R. This configuration can improve the chromaticity coordinates for white display while inhibiting a decrease in reflectance.

The sub-pixel 2702(i,j)R is electrically connected to the signal line S(j) and a wiring CSCOM, and includes a conductive film 2704, an insulating film 2706, an insulating film 2721, a conductive film 2720, an insulating film 2728, and a conductive film 2751 (see FIGS. 20A and 20B). The wiring CSCOM functions as one electrode of a capacitor, the conductive film 2704 functions as a gate electrode, the insulating film 2706 functions as a gate insulating film, and the conductive film 2720 functions as a second gate electrode. The insulating film 2721 has a function of inhibiting diffusion of an impurity, the insulating film 2728 has a function of eliminating a level difference caused by various structures, and the conductive film 2751 has a function of applying an electric field that controls the orientation of liquid crystal of a liquid crystal element.

### <Specifications>

Table 1 shows specifications of the fabricated display portion 2730. The display portion 2730 can be driven at two different frequencies. For example, the display portion 2730 can display moving images with the selection signal supplied at a frequency of 60 Hz; the display portion 2730 can display a still image with the selection signal supplied at a frequency of 1 Hz.

TABLE 1

| | |
|---|---|
| Pixel density | 434 ppi |
| Number of pixels | 1536 (H) × 2048 × RGB (V) |
| Aperture ratio | 81% |
| Reflectance | 28% |
| NTSC ratio | 37% |
| Driving frequency | Moving images: 60 Hz |
| | Still image: 1 Hz |

### <Driving Method>

In this example, a method in which a signal having a different polarity from a signal supplied to the signal line S(j) is supplied to the signal line S(j+1) adjacent to the signal line S(j) is employed as a method for driving the display portion 2730. Accordingly, power consumption can be reduced. Note that a potential of the sub-pixel 2702(i,j)R electrically connected to the signal line S(j) influences on a region of the sub-pixel 2702(i, j+1)R electrically connected to the signal line S(j+1) adjacent to the signal line S(j).

The sub-pixel 2702(i,j)R has a rectangular shape, and its short sides are along the column direction at which the signal line S(j) extends, and its long side are along the row direction at which the scan line G(i) extends. With this configuration, a region in the sub-pixel 2702(i, j+1)R influenced by the potential of the sub-pixel 2702(i,j)R can be small.

For example, in the case where the potential of sub-pixel 2702(i,j)R electrically connected to the signal line S(j) causes defective orientation of the liquid crystal material in the sub-pixel 2702(i, j+1)R, a region in the sub-pixel 2702(i, j+1)R where defective orientation occurs can be small.

If light leaks because of defective orientation of the liquid crystal material, the light-blocking film BM (also referred to as a black matrix) needs to be provided for blocking unintended light, thereby decreasing the aperture ratio of the sub-pixel. With the above-described configuration, however, such a decrease in the aperture ratio of the sub-pixel can be avoided. Specifically, in this example, light-blocking films BM extending in the column direction are used, and a light-blocking film BM is not provided in the row direction (see FIG. 19B). In other words, a light-blocking film BM is not provided between the sub-pixel 2702(i,j)R and sub-pixel 2702(i, j+1)R. Therefore, an aperture ratio as high as 81% and a reflectance as high as 28% can be achieved even with a high pixel density of 434 ppi.

A signal having a different polarity from a signal supplied to the signal line S(j) is supplied to the signal line S(j+1). The sub-pixel 2702(i, j+1)R is electrically connected to the signal line S(j+1), is adjacent to the sub-pixel 2702(i,j)R, and is configured to display the same color as the sub-pixel 2702(i,j)R displays (see FIG. 19A). With this configuration, the influence on part of the sub-pixel 2702(i, j+1) by the potential of the sub-pixel 2702(i,j)R can be small.

For example, in the case where an electric field in the horizontal direction (corresponding to the row direction) is generated between the sub-pixel 2702(i,j)R and the sub-pixel 2702(i, j+1)R, splay alignment or bend alignment is formed and flexoelectric polarization is generated. The flexoelectric polarization might become an occurrence factor of flickering due to refresh operation because it is influenced by polarity (orientation) inversion caused by the refresh operation. In particular, flickering is easily perceived when the refresh operation is performed at a frequency of lower than 30 Hz.

With the above-described configuration, however, since the sub-pixel 2702(i, j+1)R is configured to display the same color as the sub-pixel 2702(i,j)R displays, flickering of the same color component occurs. This flickering is less likely to be perceived than flickering with a color deviation.

### <Evaluation Results>

As shown by the evaluation results, the information processing device fabricated in this embodiment can display favorable images. Thus, the novel information processing device can be highly convenient or reliable.

By supplying signals with different polarities to sub-pixels that display the same color, the influence of the signals with different polarities can be reduced (see FIG. 19B). As a result, a color deviation can be inhibited, and the color reproducibility with an NTSC ratio of 37% was achieved in the reflective display device (see FIG. 21A).

Measured were changes in reflectance with time under the conditions that images with different gray levels are displayed by a method in which the selection signal is supplied at a frequency of 1 Hz. Specifically, an image with a gray level of 100% (i.e., a white image), an image with a gray level of 0% (i.e., a black image), and images with other gray levels (gray images) were displayed. As the gray images, images with gray levels of 75%, 52%, and 32% were displayed while the reflectances were measured.

The reflectances were normalized under the assumption that the highest reflectance observed in the measurement period was regarded as 100 (see FIG. 21B). A change in reflectance with time was less than 1.22% on any of the images; therefore, perceivable flickering was suppressed on the display portion.

According to the visual transfer function based on the mathematical model for visual system suggested by Peter. G. J. Barten, when a 6-inch display was looked from a distance of 30 cm for general reading, the minimum change in luminance that is perceived as flickering is estimated to be approximately 1.22%.

In this specification and the like, for example, when it is explicitly described that X and Y are connected, the case where X and Y are electrically connected, the case where X and Y are functionally connected, and the case where X and Y are directly connected are included therein. Accordingly, another element may be interposed between elements having a connection relation shown in drawings and texts, without limiting to a predetermined connection relation, for example, the connection relation shown in the drawings and the texts.

Here, X and Y each denote an object (e.g., a device, an element, a circuit, a line, an electrode, a terminal, a conductive film, or a layer).

For example, in the case where X and Y are directly connected, an element that enables electrical connection between X and Y (e.g., a switch, a transistor, a capacitor, an inductor, a resistor, a diode, a display element, a light-emitting element, or a load) is not connected between X and Y, and X and Y are connected without the element that enables electrical connection between X and Y (e.g., a switch, a transistor, a capacitor, an inductor, a resistor, a diode, a display element, a light-emitting element, or a load) provided therebetween.

For example, in the case where X and Y are electrically connected, one or more elements that enable electrical connection between X and Y (e.g., a switch, a transistor, a capacitor, an inductor, a resistor, a diode, a display element, a light-emitting element, or a load) can be connected between X and Y. A switch is controlled to be on or off. That is, a switch is conducting or not conducting (is turned on or off) to determine whether current flows therethrough or not. Alternatively, the switch has a function of selecting and changing a current path. Note that the case where X and Y are electrically connected includes the case where X and Y are directly connected.

For example, in the case where X and Y are functionally connected, one or more circuits that enable functional connection between X and Y (e.g., a logic circuit such as an inverter, a NAND circuit, or a NOR circuit; a signal converter circuit such as a DA converter circuit, an AD converter circuit, or a gamma correction circuit; a potential level converter circuit such as a power source circuit (e.g., a step-up circuit or a step-down circuit) or a level shifter circuit for changing the potential level of a signal; a voltage source; a current source; a switching circuit; an amplifier circuit such as a circuit that can increase signal amplitude, the amount of current, or the like, an operational amplifier, a differential amplifier circuit, a source follower circuit, or a buffer circuit; a signal generation circuit; a memory circuit; and/or a control circuit) can be connected between X and Y. Note that for example, in the case where a signal output from Xis transmitted to Y even when another circuit is interposed between X and Y, X and Y are functionally connected. Note that the case where X and Y are functionally connected includes the case where X and Y are directly connected and the case where X and Y are electrically connected.

Note that when it is explicitly described that X and Y are electrically connected, the case where X and Y are electrically connected (i.e., the case where X and Y are connected with another element or another circuit provided therebetween), the case where X and Y are functionally connected (i.e., the case where X and Y are functionally connected with another circuit provided therebetween), and the case where X and Y are directly connected (i.e., the case where X and Y are connected without another element or another circuit provided therebetween) are included therein. That is, in this specification and the like, the explicit description “X and Y are electrically connected” is the same as the description “X and Y are connected”.

For example, any of the following expressions can be used for the case where a source (or a first terminal or the like) of a transistor is electrically connected to X through (or not through) Z1 and a drain (or a second terminal or the like) of the transistor is electrically connected to Y through (or not through) Z2, or the case where a source (or a first terminal or the like) of a transistor is directly connected to one part of Z2 and another part of Z1 is directly connected to X while a drain (or a second terminal or the like) of the transistor is directly connected to one part of Z2 and another part of Z2 is directly connected to Y.

Examples of the expressions include, “X, Y, a source (or a first terminal or the like) of a transistor, and a drain (or a second terminal or the like) of the transistor are electrically connected to each other, and X, the source (or the first terminal or the like) of the transistor, the drain (or the second terminal or the like) of the transistor, and Y are electrically connected to each other in this order”, “a source (or a first terminal or the like) of a transistor is electrically connected to X, a drain (or a second terminal or the like) of the transistor is electrically connected to Y, and X, the source (or the first terminal or the like) of the transistor, the drain (or the second terminal or the like) of the transistor, and Y are electrically connected to each other in this order”, and “X is electrically connected to Y through a source (or a first terminal or the like) and a drain (or a second terminal or the like) of a transistor, and X, the source (or the first terminal or the like) of the transistor, the drain (or the second terminal or the like) of the transistor, and Y are provided to be connected in this order”. When the connection order in a circuit structure is defined by an expression similar to the above examples, a source (or a first terminal or the like) and a drain (or a second terminal or the like) of a transistor can be distinguished from each other to specify the technical scope.

Other examples of the expressions include, “a source (or a first terminal or the like) of a transistor is electrically connected to X through at least a first connection path, the first connection path does not include a second connection path, the second connection path is a path between the source (or the first terminal or the like) of the transistor and a drain (or a second terminal or the like) of the transistor, Z1 is on the first connection path, the drain (or the second terminal or the like) of the transistor is electrically connected to Y through at least a third connection path, the third connection path does not include the second connection path, and Z2 is on the third connection path”. Another example of the expression is “a source (or a first terminal or the like) of a transistor is electrically connected to X at least with a first connection path through Z1, the first connection path does not include a second connection path, the second connection path includes a connection path through which the transistor is provided, a drain (or a second terminal or the like) of the transistor is electrically connected to Y at least with a third connection path through Z2, and the third connection path does not include the second connection path”. Still another example of the expression is “a source (or a first terminal or the like) of a transistor is electrically connected to X through at least Z1 on a first electrical path, the first electrical path does not include a second electrical path, the second electrical path is an electrical path from the source (or the first terminal or the like) of the transistor to a drain (or a second terminal or the like) of the transistor, the drain (or the second terminal or the like) of the transistor is electrically connected to Y through at least Z2 on a third electrical path, the third electrical path does not include a fourth electrical path, and the fourth electrical path is an electrical path from the drain (or the second terminal or the like) of the transistor to the source (or the first terminal or the like) of the transistor”. When the connection path in a circuit structure is defined by an expression similar to the above examples, a source (or a first terminal or the like) and a drain (or a second terminal or the like) of a transistor can be distinguished from each other to specify the technical scope.

Note that these expressions are examples and there is no limitation on the expressions. Here, X, Y, Z1, and Z2 each denote an object (e.g., a device, an element, a circuit, a wiring, an electrode, a terminal, a conductive film, and a layer).

Even when independent components are electrically connected to each other in a circuit diagram, one component has functions of a plurality of components in some cases. For example, when part of a wiring also functions as an electrode, one conductive film functions as the wiring and the electrode. Thus, “electrical connection” in this specification includes in its category such a case where one conductive film has functions of a plurality of components.

This application is based on Japanese Patent Application serial no. 2015-052913 filed with Japan Patent Office on Mar. 17, 2015 and Japanese Patent Application serial no. 2015-057168 filed with Japan Patent Office on Mar. 20, 2015, the entire contents of which are hereby incorporated by reference.

What is claimed is:

1. An information processing device comprising:
an arithmetic device comprising a memory portion that stores a program; and
an input/output device,
wherein the arithmetic device is configured to receive positional information and supply image information and control information,
wherein the input/output device is configured to supply the positional information and receive the image information and the control information,
wherein the input/output device comprises a display portion that displays the image information and an input portion that supplies the positional information,
wherein the display portion comprises a reflective liquid crystal element and a pixel circuit electrically connected to the liquid crystal element,
wherein the input portion is configured to detect a position of a pointer and supply positional information determined in accordance with the position,
wherein the arithmetic device is configured to determine a moving speed of the pointer in accordance with the positional information, and
wherein the arithmetic device is configured to adjust a contrast or brightness of the image information in accordance with the moving speed of the pointer.

2. The information processing device according to claim 1, wherein the pixel circuit comprises a transistor including an oxide semiconductor.

3. The information processing device according to claim 1, wherein the program comprises:
a first step of initializing setting;
a second step of allowing interrupt processing;
a third step of displaying image information in a first or second mode selected in the first step or the interrupt processing;
a fourth step of determining to move to a fifth step when a termination instruction is supplied and to move to the third step when the termination instruction is not supplied; and
the fifth step of terminating the program,
wherein the interrupt processing comprises sixth to eighth steps:
the sixth step of determining to move to the seventh step when a predetermined event is supplied and to move to the eighth step when the predetermined event is not supplied;
the seventh step of changing a mode; and
the eighth step of terminating the interrupt processing, and
wherein in the first mode in the third step, a contrast of image information when a moving speed of a pointer is higher than a predetermined speed is lower than a contrast of image information when the moving speed of the pointer is lower than the predetermined speed.

4. The information processing device according to claim 1, wherein the program comprises:
a first step of initializing setting;
a second step of allowing interrupt processing;
a third step of displaying image information in a first or second mode selected in the first step or the interrupt processing;
a fourth step of determining to move to a fifth step when a termination instruction is supplied and to move to the third step when the termination instruction is not supplied; and
the fifth step of terminating the program,
wherein the interrupt processing comprises sixth to eighth steps:
the sixth step of determining to move to the seventh step when a predetermined event is supplied and to move to the eighth step when the predetermined event is not supplied;
the seventh step of changing a mode; and
the eighth step of terminating the interrupt processing,
wherein in the first mode in the third step, when a moving speed of a pointer is higher than a predetermined speed, image information having a lower contrast than image information in the second mode is displayed, and when the moving speed of the pointer is lower than the predetermined speed, image information having a higher contrast than the image information in the second mode is displayed, and
wherein in the second mode in the third step, a selection signal is suppled at a lower frequency than in the first mode.

5. The information processing device according to claim 1,
wherein the display portion includes a pixel for displaying blue, a pixel for displaying green, and a pixel for displaying red, and
wherein an area of the pixel for displaying blue is larger than an area of a pixel for displaying a color other than blue.

6. The information processing device according to claim 1,
wherein the reflective liquid crystal element comprises a liquid crystal layer and a conductive film that reflects light entering through the liquid crystal layer,
wherein the conductive film has a region overlapping with a semiconductor film of the transistor and a conductive film functioning as a gate electrode of the transistor, and
wherein the semiconductor film is provided between the conductive film and the conductive film functioning as a gate electrode.

7. The information processing device according to claim 1, wherein the input portion comprises at least one of a keyboard, a hardware button, a pointing device, a touch sensor, an imaging device, an audio input device, a viewpoint input device, and a pose detection device.
